(19) United States
(12) Patent Application Publication
(10) Pub. No.: US 2013/0126799 A1
(43) Pub. Date: May 23, 2013

(54) ELECTROCONDUCTIVE FILM, TOUCH PANEL AND SOLAR BATTERY

(71) Applicant: FUJIFILM CORPORATION, Tokyo (JP)

(72) Inventor: Kenji NAOI, Ashigarakami-gun (JP)

(73) Assignee: FUJIFILM CORPORATION, Tokyo (JP)

(21) Appl. No.: 13/722,444

(22) Filed: Dec. 20, 2012

Related U.S. Application Data
(63) Continuation of application No. PCT/JP2011/064353, filed on Jun. 23, 2011.

(30) Foreign Application Priority Data
Jun. 24, 2010 (JP) 2010-144020
Apr. 13, 2011 (JP) 2011-089297

(51) Int. Cl. H01B 1/02

(52) U.S. Cl. CPC H01B 1/02; Y10S 977/762; Y10S 977/783; B82Y 30/00
USPC 252/514; 252/512; 977/762; 977/783

(57) ABSTRACT

An electroconductive film including: electroconductive fibers, wherein the electroconductive film satisfies the following expression: 0.01<X/A<0.9, where X/A is an atomic ratio of X to A, where X is an amount of elements constituting the electroconductive fibers in the electroconductive film and X is an amount of halogen elements in the electroconductive film.

### CROSS-REFERENCE TO RELATED APPLICATION

This is a continuation application of PCT/JP2011/064353, filed on Jun. 23, 2011.

### BACKGROUND OF THE INVENTION

1. Field of the Invention

The present invention relates to an electroconductive film and a touch panel and a solar battery (or a solar cell) each using the electroconductive film.

2. Description of the Related Art

In recent years, demand for touch panels has rapidly been expanding for use in, for example, portable game machines and cell phones. ITO (indium tin oxide) has widely been used as a transparent electroconductive material in touch panels. Besides, reports have been presented on development of transparent electroconductive films using silver nanowires. Silver nanowires are generally synthesized under high-temperature conditions using organic solvents. In addition, depending on the diameter of the silver nanowires synthesized, the transparent electroconductor becomes high in haze and considerably low in contrast. Furthermore, unless the uppermost surface layer is coated with, for example, a photocurable resin, the practical-level durability cannot be obtained. This coating decreases the resistance of the transparent electroconductor, degrading uniformity in surface resistance.

In one proposal for solving the above problems, metal particles are mixed with metal nanowires, and the metal particles are melted by the action of external energy, to thereby improve contact between the metal nanowires to achieve low resistance (see Japanese Patent Application Laid-Open (JP-A) No. 2009-94033).

In this proposal, however, it is difficult to stably disperse both the metal particles and the metal nanowires in their production step, which requires a step of synthesizing the metal particles, a washing step, a concentrating step and other steps in addition to the production steps for the metal nanowires. Furthermore, a new problem arises that the metal nanowires whose diameters are relatively small are melted by the action of light, to thereby cause electrical disconnection leading to increase in resistance. Particularly for outdoor use, a high level of light resistance is required and thus drastic measures are necessary.

Meanwhile, as a process performable at low costs and with low environmental load, attempts have been made to develop a technique of forming wiring by coating an ink containing nanoparticles through means of, for example, printing or inkjetting. One proposal provides silver-coated copper particles each containing a copper particle and silver coated on at least part of the surface of the copper particle where the amount of halogen elements in the silver-coated copper particles is 20 ppm by mass or less relative to that of the copper (see JP-A No. 2010-77495). This proposal discloses that the effects of suppressing migration and corrosion of electronic materials are obtained by reducing the amount of halogen elements relative to that of metal particles.

However, this proposal does not use metal nanowires or describe that light resistance is improved by reducing the amount of halogen elements in an electroconductive film.

### SUMMARY OF THE INVENTION

The present invention aims to solve the above existing problems and provide the following: an electroconductive film having high transmittance with respect to lights with long wavelengths, having high electroconductivity, and improved light resistance and migration resistance; and a touch panel and a solar battery each using the electroconductive film.

The present inventor conductive extensive studies to solve the above problems and has found that even an electroconductive film containing, as electroconductive fibers, thin metal nanowires synthesized in an aqueous system can have high transmittance with respect to lights with long wavelengths, high electroconductivity, and improved light resistance and migration resistance, by adjusting the amount of halogen elements therein to a low level.

The present invention is based on the finding obtained by the present inventor. Means for solving the above problems are as follows.

<1> An electroconductive film including:
electroconductive fibers,
wherein the electroconductive film satisfies the following expression:

0.01<X/A<0.9,

where X/A is an atomic ratio of X to A, where A is an amount of elements constituting the electroconductive fibers in the electroconductive film and X is an amount of halogen elements in the electroconductive film.

<2> The electroconductive film according to <1>, wherein the electroconductive film satisfies the following expression: 0.1≦X/A<0.9.

<3> The electroconductive film according to <1> or <2>, wherein the electroconductive film satisfies the following expression: 0.4≦X/A<0.9.

<4> The electroconductive film according to any one of <1> to <3>, wherein the amount of the halogen elements in the electroconductive film is 400,000 ppm by mass or less.

<5> The electroconductive film according to <4>, wherein the amount of the halogen elements in the electroconductive film is 4,000 ppm by mass to 300,000 ppm by mass.

<6> The electroconductive film according to any one of <1> to <5>, wherein the electroconductive film has a surface resistance of 500 Ω/sq. or less.

<7> The electroconductive film according to any one of <1> to <6>, wherein the electroconductive fibers are metal nanowires.

<8> The electroconductive film according to <7>, wherein the metal nanowires are formed of silver or formed of an alloy formed between silver and a metal other than silver.

<9> The electroconductive film according to any one of <1> to <8>, wherein the electroconductive fibers have an average minor axis length of 50 nm or less and have an average major axis length of 1 μm or more.

<10> The electroconductive film according to any one of <1> to <9>, wherein an amount of the electroconductive fibers in the electroconductive film is 0.005 g/m² to 0.5 g/m².

<11> The electroconductive film according to any one of <1> to <10>, further including a polymer, wherein a mass ratio of A to B is 0.2 to 3, where A is an amount of the electroconductive fibers in the electroconductive film and B is an amount of the polymer in the electroconductive film.

<12> A touch panel including:

the electroconductive film according to any one of <1> to <11>.

<13> A solar battery including:
the electroconductive film according to any one of <1> to <11>.

<14> An electroconductor including:
the electroconductive film according to any one of <1> to <11>; and a support,
the electroconductive film being on the support.

<15> A method for producing an electroconductor, the method including:

forming an electroconductive layer on a support from an electroconductive layer composition containing electroconductive fibers and a polymer; and

patternwise coating the electroconductive layer with a dissolution liquid which dissolves or cleaves the electroconductive fibers.

<16> The method according to <15>, wherein parts of the electroconductive layer where the dissolution liquid has been patternwise coated are non-electroconductive parts.

<17> The method according to <15> or <16>, wherein a mass ratio of A to B is 0.2 to 3, where A is an amount of the electroconductive fibers in the electroconductive layer and B is an amount of the polymer in the electroconductive layer.

<18> The method according to any one of <15> to <17>, wherein the dissolution liquid has a viscosity at 25° C. of 5 mPa·s to 300,000 mPa·s.

<19> The method according to any one of <15> to <18>, wherein the patternwise coating is performed by screen printing.

<20> The method according to any one of <15> to <18>, wherein the patternwise coating is performed by inkjet printing.

<21> The method according to any one of <15> to <18>, wherein the patternwise coating is performed by immersing the electroconductive layer in the dissolution liquid.

<22> The method according to any one of <15> to <21>, wherein the dissolution liquid has an effect of oxidizing the electroconductive fibers.

<23> A method for producing an electroconductor, the method including:

forming an electroconductive layer on a support from an electroconductive layer composition containing electroconductive fibers and a polymer;

patternwise exposing the electroconductive layer to light; and

developing the exposed electroconductive layer.

The present invention can provide an electroconductive film having high transmittance with respect to lights with long wavelengths, having high electroconductivity, and improved light resistance and migration resistance; and a touch panel and a solar battery each using the electroconductive film. These can solve the existing problems.

### BRIEF DESCRIPTION OF THE DRAWINGS

FIG. 1 is a schematic, cross-sectional view of one exemplary touch panel.

FIG. 2 is a schematic, explanatory view of another exemplary touch panel.

FIG. 3 is a schematic, plan view of one exemplary arrangement of electroconductors in the touch panel illustrated in FIG. 2.

FIG. 4 is a schematic, cross-sectional view of still another exemplary touch panel.

### DETAILED DESCRIPTION OF THE INVENTION

### (Electroconductive Film)

An electroconductive film of the present invention contains electroconductive fibers, preferably further contains a polymer; and, if necessary, further contains other ingredients.

The shape, structure, and size of the electroconductive film are not particularly limited and may be appropriately selected depending on the intended purpose. Examples of the shape include a film and a sheet, and examples of the planar shape thereof include a rectangle and a circle. Examples of the structure include a monolayer structure and a laminated structure. The size may be appropriately selected depending on the intended application.

The electroconductive film is flexible, and preferably is transparent. The term “transparent” encompasses colorless and transparent, colored and transparent, semitransparent, and colored and semitransparent.

The electroconductive film may be patterned or not patterned. In the case of the patterned electroconductive film, as described in the below paragraph “Production method of electroconductor” in detail, a dissolution liquid which dissolves or cleaves the electroconductive fibers (hereinafter may be referred to as “dissolution liquid”) is preferably patternwise coated on the electroconductive film, resulting in non-electroconductive parts on which the dissolution liquid is coated and electroconductive parts on which the dissolution liquid is not coated to thereby form a two-dimensional planar pattern depending on presence or absence of electroconductivity. Alternatively, a pattern is preferably formed by a photolithography method using a mixture of a photosensitive resin and electroconductive fibers.

In the present invention, the atomic ratio (X/A) of the amount of an element constituting the electroconductive fibers in the electroconductive film (A) and the amount of a halogen element in the electroconductive film (X) meets the following expression: 0.01<X/A<0.9. The upper limit of the atomic ratio is more preferably 0.89 or less, further preferably 0.85 or less, further more preferably 0.65 or less. On the other hand, the lower limit thereof is more preferably 0.1 or more. The range thereof is preferably 0.1≦X/A<0.9 (more strictly 0.10≦X/A<0.90), more preferably 0.4 X/A<0.9 (more strictly 0.40≦X/A<0.90), further preferably 0.40 X/A≦0.85.

When the atomic ratio (X/A) is 0.9 or more, the light resistance and the migration resistance may be deteriorated. When the atomic ratio (X/A) is 0.01 or less, a longer process time may be needed. For example, when the electroconductive fibers are silver nanowires and the halogen elements is chlorine, bromine, fluorine or iodine, the atomic ratio (X/A) of the amount of silver in the electroconductive film (A) and the total amounts of chlorine, bromine, fluorine and iodine in the electroconductive film (X) is determined.

The atomic ratio (X/A) can be determined with, for example, an X-ray fluorescence spectrometer (XRF) or ion chromatography.

The amount of the halogen element in the electroconductive film is preferably 400,000 ppm by mass or less, more preferably 300,000 ppm by mass or less, further preferably 270,000 ppm by mass or less. The lower limit thereof is preferably 4,000 ppm by mass or more, more preferably 10,000 ppm by mass or more, further preferably 30,000 ppm by mass or more. The preferred range thereof is more preferably 4,000 ppm by mass to 300,000 ppm by mass, further preferably 10,000 ppm by mass to 270,000 ppm by mass. When the amount is more than 400,000 ppm by mass, the light resistance and the migration resistance may be deteriorated. The amount of the halogen element in the electroconductive film can be decreased through, for example, ultrasonic washing. In this case, however, the electroconductive fibers may be deteriorated, resulting in increasing the surface resistance and decreasing the electroconductivity.

The amount of the halogen element in the electroconductive film can be determined with, for example, an X-ray fluorescence spectrometer (XRF) or an ion chromatography.

Examples of the halogen element include elements derived from a manufacturing process of the electroconductive fibers such as chlorine, bromine, fluorine or iodine. Among them, the amounts of chlorine, bromine, and iodine are particularly preferably controlled because these elements are highly likely to be included in various reagents as contaminants.

Methods for controlling the amount of the halogen element in the electroconductive film include (1) a method in which a coating liquid for forming an electroconductive layer is subjected to ultrafiltration, (2) a method in which a solvent such as pure water is added to the coating liquid for forming the electroconductive layer, and then the resultant solution is repeatedly cleaned by subjecting to centrifugation and removing the resultant supernatant, and (3) a method in which the electroconductive layer is formed, followed by washing (for example, by immersing in a washing solvent such as pure water). Among them, the above-described method (3) is particularly preferred.

In the ultrafiltration step of the method (1), the coating liquid for forming the electroconductive layer is subjected to ultrafiltration through an ultrafiltration membrane, and then the ultrafiltrated coating liquid for forming the electroconductive layer is used to form the electroconductive film. The molecular weight cutoff of the ultrafiltration membrane is preferably 5,000 to 200,000. The ultarfiltration may be performed in a dead-end mode or a cross-flow mode. Preferred is the cross-flow mode.

In the method (2), the washing step is preferably repeated for one or more times, more preferably twice or more times, further preferably twice to five times. The amount of the solvent such as pure water added is preferably 10 to 500 relative to 1 of the coating liquid for forming the electroconductive layer on the volume basis.

In the method (3), examples of the washing solvent include water, methanol, ethanol, normal propanol, isopropanol, ethyleneglycol, and acetone. These may be used alone or in combination. Among them, particularly preferred is water. Examples thereof include purified water such as ion-exchanged water, ultrafiltrated water, Milli Q water and distilled water; pure water; or super pure water. Among them, particularly preferred is pure water.

The electroconductive film is immersed in the washing solvent. It is also preferred that the electroconductive film is sprayed, showered, or rinsed with the washing solvent in order to achieve an effect similar to that of the immersing. More preferred is a combination of spraying, showering and/or rinsing.

The immersing is preferably performed at 5° C. to 40° C. for 1 sec to 30 min, more preferably at 10° C. to 30° C. for 3 sec to 3 min when the washing solvent is pure water.

### <Electroconductive Fiber>

The electroconductive fiber has preferably either a solid structure or a hollow structure.

A fiber having a solid structure may be referred to as a wire, and a fiber having a hollow structure may be referred to as a tube.

An electroconductive fiber having an average minor axis length of 1 nm to 1,000 nm, an average major axis length of 1 μm to 100 μm, and a solid structure may be referred to as a nanowire.

An electroconductive fiber having an average minor axis length of 1 nm to 1,000 nm, an average major axis length of 0.1 μm to 1,000 μm, and a hollow structure may be referred to as a nanotube.

The material of the electroconductive fiber is not particularly limited so long as it has electroconductivity. Preferred material is a metal and/or a carbon. Among them, the electroconductive fiber is preferably a metal nanowire, a metal nanotube, and/or a carbon nanotube.

### <<Metal Nanowire>>

### —Metal—

The material of the metal nanowire is not particularly limited and may be appropriately selected depending on the intended purpose. For example, the material is preferably at least one metal selected from the 4^{th}, 5^{th} and 6^{th} periods of the long form of Periodic Table (IUPAC 1991), more preferably at least one metal selected from the 2^{nd} to 14^{th} groups thereof, yet more preferably at least one metal selected from the 2^{nd} group, the 8^{th} group, 9^{th} group, 10^{th} group, 12^{th} group, 13th group and 14th group thereof. Moreover, it is particularly preferred that the above at least one metal be contained in the material as a main component.

Examples of the metal include copper, silver, gold, platinum, palladium, nickel, tin, cobalt, rhodium, iridium, iron, ruthenium, osmium, manganese, molybdenum, tungsten, niobium, tantalum, titanium, bismuth, antimony, lead or alloys thereof. Among them, silver, and alloys formed between silver and a metal(s) other than silver are particularly preferred, since they are excellent in electroconductivity.

Examples of the metal(s) other than silver include platinum, osmium, palladium, and iridium. These may be used alone or in combination.

### —Shape—

The shape of each of the metal nanowires is not particularly limited and may be appropriately selected depending on the intended purpose. For example, the metal nanowire may have any shape such as a cylindrical columnar shape, a rectangular parallelepiped shape, and a columnar shape with a polygonal cross-section. When high transparency is required in use, the metal nanowire preferably has a cylindrical columnar shape or a polygonal cross-section whose corners are rounded.

The shape of the cross-section of the metal nanowire may be confirmed as follows. Specifically, an aqueous dispersion of the metal nanowires is coated onto a base material, and their cross-sections are observed under a transmission electron microscope (TEM).

### —Average Minor Axis Length and Average Major Axis Length—

The average minor axis length (hereinafter may be referred to as “average minor axis diameter” or “average diameter”) of the metal nanowires is preferably 50 nm or less, more preferably 1 nm to 50 nm, further preferably 10 nm to 40 nm, particularly preferably 15 nm to 35 nm.

When the average minor axis length thereof is less than 1 nm, the metal nanowires may be decreased in oxidation resistance and hence degraded in durability. Whereas when the average minor axis length thereof is more than 50 nm, scattering due to the metal nanowires occurs, resulting in that satisfactory transparency cannot be obtained in some cases.

The average minor axis length of the metal nanowires is measured with a transmission electron microscope (TEM) (product of JEOL Ltd., JEM-2000FX). Specifically, 300 metal nanowires are observed under the transmission electron microscope. Based on the average values obtained from the observation, the average minor axis length of the metal nanowires is obtained. Notably, when the cross-sectional shape of the metal nanowire in the direction along the minor axis thereof is not circular, the minor axis length thereof is defined as the longest length thereof.

The average major axis length of the metal nanowires (hereinafter may be referred to as “average length”) is preferably 1 μm or more, more preferably 1 μm to 40 μm, further preferably 3 μm to 35 μm, particularly preferably 5 μm to 30 μm.

When the average major axis length is less than 1 the metal nanowires are difficult to form a dense network and thus cannot be achieve sufficient electroconductivity in some cases. When the average major axis length is more than 40 μm, the metal nanowires may tangle with each other due to its too long length, resulting in forming aggregates in a manufacturing process.

The average major axis length of the metal nanowires is measured with a transmission electron microscope (TEM) (product of JEOL Ltd., JEM-2000FX). Specifically, 300 metal nanowires are observed under the transmission electron microscope. Based on the average values obtained from the observation, the average major axis length of the metal nanowires is obtained. Notably, when the metal nanowire is curved, the major axis length of the curved metal nanowire is defined as a value calculated from the radius and curvature of a circle drawn from the curved metal nanowire as an arc.

### —Production Method—

The production method for the metal nanowires may be any production method. Preferably, as described below, the metal nanowires are produced by reducing metal ions under heating in a solvent containing a halogen compound and a dispersing additive dissolved therein. Notably, in the case of a method using a halogen compound, the resultant electroconductive film contains the halogen element. Thus, the electroconductive film can achieve preferable properties by controlling the amount of the halogen element as described above.

The metal nanowire can be produced using, for example, the methods described in Japanese Patent Application Laid-Open (JP-A) Nos. 2009-215594, 2009-242880, 2009-299162, 2010-84173, and 2010-86714.

The solvent is preferably a hydrophilic solvent. Examples of the hydrophilic solvent include water, alcohols, ethers and ketones. These may be used alone or in combination.

Examples of the alcohols include methanol, ethanol, propanol, isopropanol, butanol and ethylene glycol.

Examples of the ethers include dioxane and tetrahydrofuran.

Examples of the ketones include acetone.

The heating temperature for the above heating is preferably 250° C. or lower, more preferably 20° C. to 200° C., yet more preferably 30° C. to 180° C., particularly preferably 40° C. to 170° C.

When the heating temperature is lower than 20° C., the formed metal nanowires become too long since the yield of core formation is lowered as the heating temperature becomes lower. Thus, these metal nanowires tend to be tangled each other, potentially leading to degradation of dispersion stability. Whereas when the heating temperature is higher than 250° C., the angles of the cross sections of the formed metal nanowires become sharp and thus, the transmittance of the coated film formed therefrom may be lowered.

If necessary, the temperature may be changed during the formation of metal nanowires. To change the temperature in the course of the formation may contribute to the control for formation of the core of the metal nanowires, to the prevention of generation of re-grown cores, and to the promotion of selective growth to improve the monodispersibility.

It is preferred that the reducing agent be added at the time of the heating.

The reducing agent is not particularly limited and may be appropriately selected from commonly-used reducing agents. Examples of the reducing agent include metal salts of boron hydrides, aluminum hydride salts, alkanol amines, aliphatic amines, heterocyclic amines, aromatic amines, aralkyl amines, alcohols, organic acids, reducing sugars, sugar alcohols, sodium sulfite, hydrazine compounds, dextrins, hydroquinones, hydroxylamines, ethylene glycol and glutathione. Among them, the reducing sugars, sugar alcohols that are derivatives of the reducing sugars, and ethylene glycol are particularly preferred.

Examples of the metal salts of boron hydrides include sodium boron hydride and potassium boron hydride.

Examples of the aluminum hydride salts include lithium aluminum hydride, potassium aluminum hydride, cesium aluminum hydride, beryllium aluminum hydride, magnesium aluminum hydride and calcium aluminum hydride.

Examples of the alkanol amines include diethylamino ethanol, ethanol amine, propanol amine, triethanol amine and dimethylamino propanol.

Examples of the aliphatic amines include propyl amine, butyl amine, dipropylene amine, ethylene diamine and triethylenepentamine.

Examples of the heterocyclic amines include piperidine, pyrrolidine, N-methylpyrrolidine and morpholine.

Examples of the aromatic amines include aniline, N-methyl aniline, toluidine, anisidine and phenetidine.

Examples of the aralkyl amines include benzyl amine, xylene diamine and N-methylbenzyl amine.

Examples of the alcohols include methanol, ethanol and 2-propanol.

Examples of the organic acids include citric acid, malic acid, tartaric acid, succinic acid, ascorbic acid or salts thereof.

Examples of the reducing sugars include glucose, galactose, mannose, fructose, sucrose, maltose, raffinose and stachyose.

Examples of the sugar alcohols include sorbitol.

Note that, there is a case where the reducing agents may also function as a dispersing additive or a solvent depending on the types of the reducing agents, and those reducing agents are also preferably used.

The metal nanowires are preferably produced through addition of a dispersing additive and a halogen compound or metal halide fine particles.

The timing when the dispersing additive and halogen compound are added may be before or after addition of the reducing agent, and may be before or after addition of the metal ions or metal halide fine particles. For producing nanowires having better monodispersibility, the halogen compound is preferably added twice or more times in a divided manner.

The dispersing additive is not particularly limited and may be appropriately selected depending on the intended purpose. Examples of the dispersing additive include amino group-containing compounds, thiol group-containing compounds, sulfide group-containing compounds, amino acids or derivatives thereof, peptide compounds, polysaccharides, synthetic polymers, and gels derived from those mentioned above. Among them, preferred are gelatin, polyvinyl alcohol, methyl cellulose, hydroxypropyl cellulose, polyalkylene amine, partial alkyl ester of polyacrylic acid, polyvinyl pyrrolidone and polyvinyl-pyrrolidine copolymer.

The structures usable for the dispersing additive can be, for example, referred to the description in “Pigment Dictionary” (edited by Seishiro Ito, published by ASAKURA PUBLISHING CO., 2000).

Depending on the type of the dispersing additive used, the shapes of metal nanowires obtained can be changed.

The halogen compound is not particularly limited, so long as it contains bromine, chlorine or iodine, and may be appropriately selected depending on the intended purpose. Preferable examples of the halogen compound include alkali halides such as sodium bromide, sodium chloride, sodium iodide, potassium bromide, potassium chloride and potassium iodide; and compounds that can be used in combination with the below-described dispersing agent.

Note that, there may be a case where the halogen compounds may also function as a dispersing additive depending on the types of the halogen compounds, and those halogen compounds are also preferably used.

Silver halide fine particles may be used instead of the halogen compound, or the halogen compound and the silver halide fine particles may be used in combination.

A single compound having the functions of both the dispersing additive and the halogen compound or silver halide fine particles may be used. Examples of the compound having the functions of both the dispersing additive and the halogen compound include hexadecyl-trimethylammonium bromide (HTAB) containing an amino group and a bromide ion, and hexadecyl-trimethylammonium chloride (HTAC) containing an amino group and a chloride ion.

The demineralizing treatment can be performed after formation of the metal nanowires through, for example, ultrafiltration, dialysis, gel filtration, decantation or centrifugation.

### <<Metal Nanotube>>

### —Metal—

The material of the metal nanotubes is not particularly limited and may be any metal. For example, the above-described material of the metal nanowires can be used.

### —Shape—

The metal nanotubes may be monolayered or multilayered. Preferred are monolayered metal nanotubes from the viewpoint of being excellent in electroconductivity and thermal conductivity.

### —Average Minor Axis Length, Average Major Axis Length, and Thickness—

The thickness of the metal nanotube (i.e., the difference between the outer diameter and the inner diameter) is preferably 3 nm to 80 nm, more preferably 3 nm to 30 nm.

When the thickness is less than 3 nm, the metal nanotube may be decreased in oxidation resistance and hence degraded in durability. When the thickness is more than 80 nm, scattering due to the metal nanotubes may occur.

The average major axis length thereof is preferably 1 μm to 40 μm, more preferably 3 μm to 35 μm, further preferably 5 μm to 30 μm.

### —Production Method—

The production method of the metal nanotubes is not particularly limited and may be any production method. The metal nanotubes can be produced by any known method such as described in U.S. Patent Application Publication No 2005/0056118.

### <<Carbon Nanotube>>

The carbon nanotube (CNT) is a material in which a sheet of carbon atoms in graphite (grapheme sheet) is arranged in mono- or multi-layered coaxial tube. A monolayer carbon nanotube is called a single-wall nanotube (SWNT), and a multilayer carbon nanotube is called a multi-wall nanotube (MWNT). Especially, a bilayer carbon nanotube is called a double-wall nanotube (DWNT). The carbon nanotubes may be monolayered or multilayered in the electroconductive fibers used in the present invention. Preferred is monolayer carbon nanotube from the viewpoint of being excellent in electroconductivity and thermal conductivity.

### —Production Method—

The production method for the carbon nanotubes is not particularly limited and may be any production method. Examples thereof include known methods such as a catalytic hydrogen reduction of carbon dioxide, an arc discharge method, a laser vaporization method, a thermal CVD method, a plasma CVD method, a vapor phase growth method, a Hipco method in which carbon monoxide is reacted with an iron catalyst under high temperature and high pressure to thereby grow in vapor phase.

Thus obtained carbon nanotubes are preferably subjected to, for example, washing, centrifugation, filtration, oxidation, or chromatography to thereby remove a residue such as a byproduct or catalytic metal in order to obtain highly purified carbon nanotubes.

### <<Aspect Ratio>>

An aspect ration of the electroconductive fibers is preferably 10 or more. The term “aspect ratio” generally means a ratio of the long side length and the short side length (average major axis length/average minor axis length) of fibrous material.

A method for measuring the aspect ratio is not particularly limited and may be appropriately selected depending on the intended purpose. For example, the aspect ratio can be measured with an electron microscope.

When the aspect ratio is measured with an electron microscope, whether the aspect ratio of the electroconductive fibers is 10 or more can be judged by observing only one visual field of the electron microscope. Alternatively, the aspect ratio of the electroconductive fibers can be entirely estimated by separately measuring the long side length and the short side length of each of the electroconductive fibers.

Notably, when the electroconductive fibers have a tubular shape, the outer diameter of the tube is used as the diameter for calculating the aspect ratio.

The aspect ratio of the electroconductive fibers is not particularly limited, so long as it is 10 or more, and is preferably 50 to 1,000,000, more preferably 100 to 1,000,000.

When the aspect ratio is less than 10, the electroconductive fibers may not form the network resulting in insufficient electroconductivity. When the aspect ratio is more than 1,000,000, a stable solution of the electroconductive fibers cannot be obtained in some cases because the electroconductive fibers may tangle with each other to form aggregates at the formation of the electroconductive fibers, during subsequent handling and/or before film formation.

### <<Ratio of Electroconductive Fibers Having Aspect Ratio of 10 or More>>

A ratio of the electroconductive fibers having an aspect ratio of 10 or more is preferably 50% by volume or more, more preferably 60% by volume or more, particularly preferably 75% by volume or more relative to the total electroconductive composition. The above percentage of the electroconductive fibers hereinafter may be referred to as “ratio of electroconductive fibers.”

When the ratio of the electroconductive fibers is less than 50%, an electroconductive material which contributes to the electroconductivity decreases, potentially leading to low electroconductivity. In addition, the electroconductive fibers may not form a dense network resulting in the voltage concentration, which may deteriorate the durability. Particles other than the electroconductive fibers are not preferred in that they do not highly contribute to the electroconductivity and do exhibit unwanted absorption at some wavelengths. Especially in the case of the metal, the spherical particles exhibiting strong plasmon absorption may deteriorate the transparency.

The ratio of the electroconductive fibers is measured as follows, for example, in the case where the electroconductive fibers are silver nanowires. First, a silver nanowire aqueous dispersion is filtrated to separate the silver nanowires from the other particles. Then, the amount of silver remaining on the filter paper and the amount of silver passing through the filter paper are respectively measured by means of ICP atomic emission spectrometer. Thereafter, the electroconductive fibers remaining on the filter paper are observed under a transmission electron microscope (TEM), and 300 electroconductive fibers are measured for minor axis length. From the measurement results, their distribution is examined to confirm that the electroconductive fibers have the average minor axis length of 200 nm or less and the average major axis length of 1 μm or more. Notably, as the filter paper, those having a pore size which is twice or more of the maximum major axis length of particles other than the electroconductive fibers having the minor axis length of 200 nm or less and the major axis length of 1 μm or more measured in a TEM image, and which is equal to or less than the minimum major axis length of the electroconductive fibers are preferably used.

The average minor axis length and the average major axis length of the electroconductive fibers can be measured by observing the electroconductive fibers with, for example, a transmission electron microscope (TEM) or an optical microscope. In the present invention, 300 electroconductive fibers are observed under a transmission electron microscope (TEM). Based on the average values obtained from the observation, the average minor axis length and the average major axis length of the electroconductive fibers are determined.

### <Polymer>

Both of a water-soluble polymer and a water-insoluble polymer may be suitably used as the polymer. Among them, particularly preferred is a water-insoluble polymer from the viewpoint of humidity durability.

### <<Water-Soluble Polymer>>

The water-soluble polymer is not particularly limited and may be appropriately selected depending on the intended purpose. Examples thereof include gelatin, gelatin derivatives, casein, agar-agar, starches, polyvinyl alcohol, polyacrylic acid copolymers, carboxymethyl cellulose, hydroxyethyl cellulose, polyvinylpyrrolidone and dextran. These may be used alone or in combination.

A ratio by mass (A/B) of the amount of the electroconductive fibers (A) and the amount of the water-soluble polymer (B) is preferably 0.2 to 3, more preferably 0.5 to 2.5.

When the ratio by mass (A/B) is less than 0.2, the amount of the polymer is excess relative to that of the electroconductive fibers and therefore even minor fluctuations in the coating amount may increase the resistance. When the ratio by mass (A/B) is more than 3, practically sufficient film strength cannot be obtained in some cases due to too small amount of the polymer.

### <<Water-Insoluble Polymer>>

The water-insoluble polymer functions as a binder, and is a polymer which is not substantially dissolved in water having a near-neutral pH. The term “water-insoluble polymer” as used herein means a polymer having an SP value (calculated by the Okitsu method) of 18 MPa^{1/2} to 30 MPa^{1/2}.

The SP value is preferably 18 MPa^{1/2} to 30 MPa^{1/2}, more preferably 19 MPa^{1/2} to 28 MPa^{1/2}, further preferably 19.5 MPa^{1/2} to 27 MPa^{1/2}.

When the SP value is less than 18 MPa^{1/2}, it may become difficult to clean adhered organic contaminants. When the SP value is more than 30 MPa^{1/2}, the conversion efficiency may decrease upon manufacturing a solar battery. It is possibly because the polymer comes to have a higher affinity to water and thus the water content in a coated film increases, resulting in high absorption in an infrared region.

Here, the SP value is calculated by the Okitsu method (Toshinao Okitsu, “Journal of the Adhesion Society of Japan” 29(3) (1993)). Specifically, the SP value is calculated using the following equation. Notably, ΔF is a value described in literature.

SP value(δ)=ΣΔF(Molar Attraction Constants)/V(molar volume)

When a plurality of water-insoluble polymers are used, an SP value (σ) and a hydrogen bonded term (σh) of the SP value are calculated using the following equation.

$$σ or {σ}_{h} = \frac{{M}_{1} {V}_{1} {σ}_{1} + {M}_{2} {V}_{2} {σ}_{2} + {M}_{3} {V}_{3} {σ}_{3} + … MnVn σ n}{{M}_{1} {V}_{1} + {M}_{2} {M}_{2} + {M}_{3} {V}_{3} + … MnVn σ}$$

where σn denotes an SP value of a water-insoluble polymer and water or a hydrogen bonded term of the SP value, Mn denotes a molar fraction of a water-insoluble polymer and water in a mixture, Vn denotes a molar volume, and n is an integer of 2 or greater and indicates the type of a solvent.

The water-insoluble polymer is not particularly limited, but preferred is a polymer having an ethylenically unsaturated group from the viewpoint of the adhesiveness of a coated film to a substrate and durability to rubbing. Among them, preferred is a water-insoluble polymer having a main chain and a side chain linked with the main chain and containing the at least one ethylenically unsaturated bond in the side chain. A plurality of the ethylenically unsaturated bonds may be contained in the side chain. Also, the ethylenically unsaturated bond may be contained in the side chain of the water-insoluble polymer together with the branched and/or alicyclic structure and/or the acid group.

The water-insoluble polymer may be appropriately selected from polymer latex described below.

Examples of acrylic polymers include NIPOL LX855, 857x2 (all products of ZEON CORPORATION); VONCOAT R3370 (product of DIC Corporation); JURYMER ET-410 (product of TOAGOSEI CO., LTD.); AE116, AE119, AE121, AE125, AE134, AE137, AE140, AE173 (all products of JSR Corporation); and ARON A-104 (product of TOAGOSEI CO., LTD.) (all trade names).

Examples of polyesters include FINETEX ES650, 611, 675, 850 (all products of DIC Corporation); WD-size, WMS (all products of Eastman Chemical Company); A-110, A-115GE, A-120, A-121, A-124GP, A-124S, A-160P, A-210, A-215GE, A-510, A-513E, A-515GE, A-520, A-610, A-613, A-615GE, A-620, WAC-10, WAC-15, WAC-17XC, WAC-20, S-110, S-110EA, S-111SL, S-120, S-140, S-140A, S-250, S-252G, S-250S, S-320, S-680, DNS-63P, NS-122L, NS-122LX, NS-244LX, NS-140L, NS-141LX, NS-282LX (all products of TAKAMATSU OIL & FAT CO., LTD.); ARON MELT PES-1000 series, PES-2000 series (all products of TOAGOSEI CO., LTD.); VYLONAL MD-1100, MD-1200, MD-1220, MD-1245, MD-1250, MD-1335, MD-1400, MD-1480, MD-1500, MD-1930, MD-1985 (all products of TOYOBO CO., LTD.); and CEPORJON ES (product of SUMITOMO SEIKA CHEMICALS CO., LTD.) (all trade names).

Examples of polyurethanes include HYDRAN AP10, AP20, AP30, AP40, 101H, VONDIC 1320NS, 1610NS (all products of DIC Corporation); D-1000, D-2000, D-6000, D-4000, D-9000 (all products of Dainichiseika Color & Chemicals Mfg. Co., Ltd.); NS-155×, NS-310A, NS-310X, NS-311X (all products of TAKAMATSU OIL & FAT CO., LTD.); and ELASTRON (Dai-ichi Kogyo Seiyaku Co., Ltd.) (all trade names).

Examples of rubbers include LACSTAR 7310K, 3307B, 4700H, 7132C (all products of DIC Corporation), and NIPOL LX416, LX410, LX430, LX435, LX110, LX415A, LX415M, LX438C, 2507H, LX303A, LX407BP series, V1004, MH5055 (all products of ZEON CORPORATION) (all trade names).

Examples of polyvinyl chlorides include G351, G576 (all products of ZEON CORPORATION); VINYBRAN 240, 270, 277, 375, 386, 609, 550, 601, 602, 630, 660, 671, 683, 680, 680S, 681N, 685R, 277, 380, 381, 410, 430, 432, 860, 863, 865, 867, 900, 900GT, 938, 950, SOLBIN C, SOLBIN CL, SOLBIN CH, SOLBIN CN, SOLBIN C5, SOLBIN M, SOLBIN MF, SOLBIN A, SOLBIN AL (all products of Nissin Chemical Industry Co., Ltd.); and S-LEC A, S-LEC C, S-LEC M (all products of SEKISUI CHEMICAL CO., LTD.); DENKAVINYL 1000GKT, DENKAVINYL 1000L, DENKAVINYL 100° C.K, DENKAVINYL 1000A, DENKAVINYL 1000LK2, DENKAVINYL 1000AS, DENKAVINYL 1000GS, DENKAVINYL 1000LT3, DENKAVINYL 1000D, DENKAVINYL 1000W (all products of DENKI KAGAKU KOGYO KABUSHIKI KAISHA) (all trade names).

Examples of polyvinylidene chlorides include L502, L513 (all products of Asahi Kasei Corp.); and D-5071 (DIC Corporation) (all trade names).

Examples of polyolefins include CHEMIPEARL 5120, SA100, V300 (all products of Mitsui Chemicals, Inc.); VONCOAT 2830, 2210, 2960 (all products of DIC Corporation), and ZAIKTHENE, CEPORJON G (all products of SUMITOMO SEIKA CHEMICALS CO., LTD.) (all trade names).

Examples of copolymerized nylons include CEPORJON PA (SUMITOMO SEIKA CHEMICALS CO., LTD.) (trade name).

Examples of polyvinyl acetates include VINYBRAN 1080, 1082, 1085W, 1108W, 1108S, 1563M, 1566, 1570, 1588C, A22J7-F2, 1128C, 1137, 1138, A20J2, A23J1, A23J1, A23K1, A23P2E, A68J1N, 1086A, 1086, 1086D, 1108S, 1187, 1241LT, 1580N, 1083, 1571, 1572, 1581, 4465, 4466, 4468W, 4468S, 4470, 4485LL, 4495LL, 1023, 1042, 1060, 1060S, 1080M, 1084W, 1084S, 1096, 1570K, 1050, 1050S, 3290, 1017AD, 1002, 1006, 1008, 1107L, 1225, 1245L, GV-6170, GV-6181, 4468W, 4468S (all products of Nissin Chemical Industry Co., Ltd.) (all trade names).

In addition, the polymer latex includes polyacryls, polylactate esters, polyurethanes, polycarbonates, polyesters, polyacetals, SBRs, and polyvinyl chlorides. These may be used alone or in combination. Among them, preferred are polyacryls, polyurethanes, polyvinyl chlorides, polyesters, polycarbonates and SBRs, more preferred are polyacryls, polyurethanes, polyvinyl chlorides, polyesters and SBRs, particularly preferred is polyacryls.

The ethylenically unsaturated bond may be linked to the main chain of the water-insoluble polymer via at least one ester group (—COO—), and the side chain of the water-insoluble polymer may be consisted of the ethylenically unsaturated bond and the ester group. Additionally, a divalent organic linking group may be present between the main chain of the water-insoluble polymer and the ester group and/or the ester group and the ethylenically unsaturated bond. The ethylenically unsaturated bond may be contained in the side chain of the water-insoluble polymer as “group having an ethylenically unsaturated bond.”

The divalent organic linking group includes styrenes, (meth)acrylates, vinyl ethers, vinyl esters, and (meth)acrylamides. Preferred are (meth)acrylates, vinyl esters, and (meth)acrylamides, and more preferred is (meth)acrylates.

The ethylenically unsaturated bond is preferably disposed by introducing the (meth)acryloyl group.

The method for introducing the (meth)acryloyl group to the side chain of the water-insoluble polymer is not particularly limited and may be appropriately selected from known methods. Examples thereof include a method in which a (meth)acrylate having an epoxy group is reacted with a water-insoluble polymer containing a repeating unit having an acid group so that the (meth)acrylate is added to the acid group, a method in which a (meth)acrylate having an isocyanate group is reacted with a water-insoluble polymer containing a repeating unit having a hydroxyl group so that the (meth)acrylate is added to the hydroxyl group, and a method in which a (meth)acrylate having a hydroxyl group is reacted with a water-insoluble polymer containing a repeating unit having an isocyanate group so that the (meth)acrylate is added to the isocyanate group.

Among them, preferred is a method in which a (meth)acrylate having an epoxy group is reacted with a water-insoluble polymer containing a repeating unit having an acid group so that the (meth)acrylate is added to the acid group, since this method can easily be performed as compared with the other methods and involves low cost.

The (meth)acrylate having both the ethylenically unsaturated bond and the epoxy group is not particularly limited, so long as it has both of these groups. For example, preferred are compounds represented by the following Structural Formulas (1) and (2).

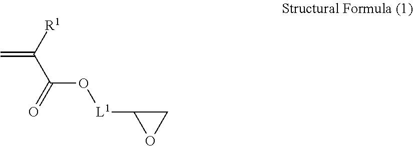

In Structural Formula (1), R¹ represents a hydrogen atom or a methyl group. L¹ represents an organic group.

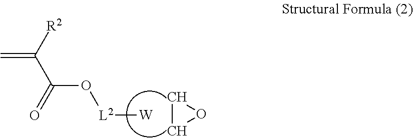

In Structural Formula (2), R² represents a hydrogen atom or a methyl group. L² represents an organic group. W represents a 4- to 7-membered cyclic aliphatic hydrocarbon group.

Among the compounds represented by Structural Formulas (1) and (2), preferred are the compounds represented by Structural Formula (1) from the viewpoint of being excellent in developabilitly and film strength when used as a negative or positive resist in combination with a photocurable resin. In Structural Formulas (1) and (2), L¹ and L² more preferably each independently represent a C1-C4 alkylene group.

The compounds represented by Structural Formulas (1) and (2) are not particularly limited. Examples thereof include the following compounds (1) to (10).

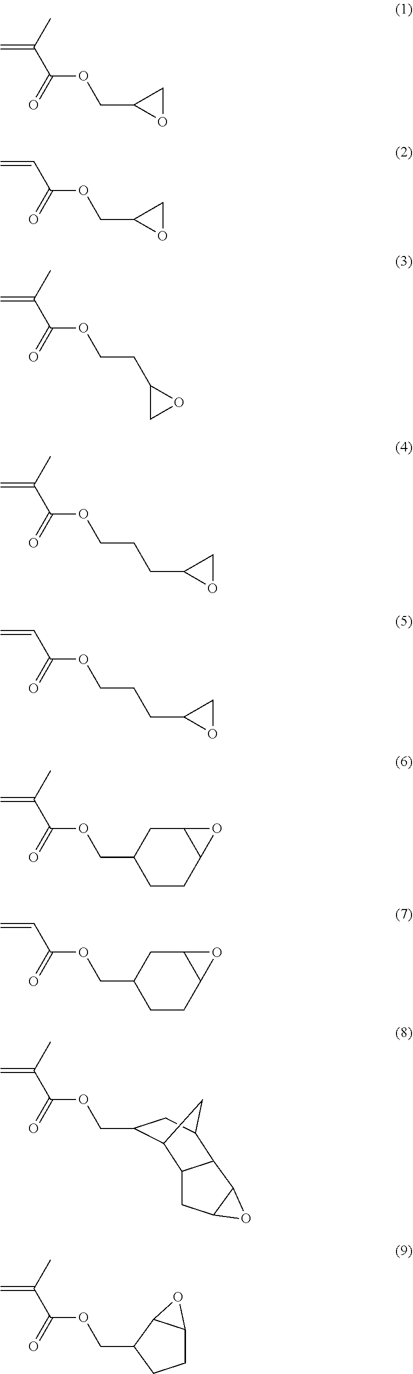

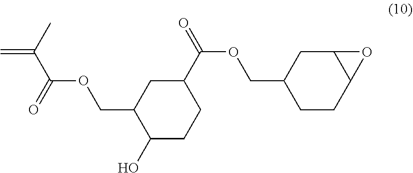 [SMILES: C=C(C)C(=O)OCC1CC(C(=O)OCC2CCC3OC3C2)CCC1O]

The water-insoluble polymer includes a water-insoluble polymer represented by the following General Formula (1).

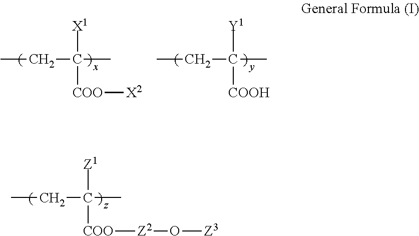

In General Formula (1), X¹, Y¹ and Z¹ each independently represent a hydrogen atom or a methyl group, X² represents an organic group having a branched structure or an alicyclic structure, Z² represents a single bond or a divalent organic group, Z³ represents an acryloyl group or a methacryloyl group, and x, y or z denotes a molar ratio of a repeating unit indicated by x, y or z and is a numerical value greater than 0 but smaller than 100, provided that a sum of x, y and z is 100.

Preferably, x is 10 to 75, y is 5 to 70, and z is 10 to 70.

Examples of the organic group X² having a branched structure include C3-C8 branched alkyl groups such as an i-propyl group, a s-butyl group, a t-butyl group, an i-amyl group, a t-amyl group and a 2-octyl group, with an i-propyl group, a s-butyl group and a t-butyl group being particularly preferred.

Examples of the organic group X² having an alicyclic structure include C5-C20 alicyclic hydrocarbon groups such as a cyclopentyl group, a cyclohexyl group, a cycloheptyl group, a cyclooctyl group, a norbornyl group, an isobornyl group, an adamantyl group, a tricyclodecyl group, a dicyclopentenyl group, a dicyclopentanyl group, a tricyclopentenyl group and a tricyclopentanyl group. Each of these groups may be linked via a —CH₂CH₂O— group to the COO— in General Formula (1). Among them, preferred are a cyclohexyl group, a norbornyl group, an isobornyl group, an adamantyl group, a tricyclodecyl group, a tricyclopentenyl group, and a tricyclopentanyl group. Particularly preferred are a cyclohexyl group, a norbornyl group, an isobornyl group, and a tricyclopentenyl group.

Examples of the divalent organic group Z² include C3-C7 alkylene groups having a hydroxy group such as a 2-hydroxy-1,3-propylene group; and C6-C9 divalent alicyclic hydrocarbon groups having a hydroxyl group such as a 2-hydroxy-1,4-cyclohexylene group.

Specific examples of the water-insoluble polymer represented by the above General Formula (1) include compounds having the following structures (exemplary compounds P-1 to P-35). These exemplary compounds P-1 to P-35 each have a weight average molecular weight of 5,000 to 300,000.

Also, x, y or z described in the exemplary compounds denotes a compositional ratio (molar ratio) of a corresponding repeating unit.

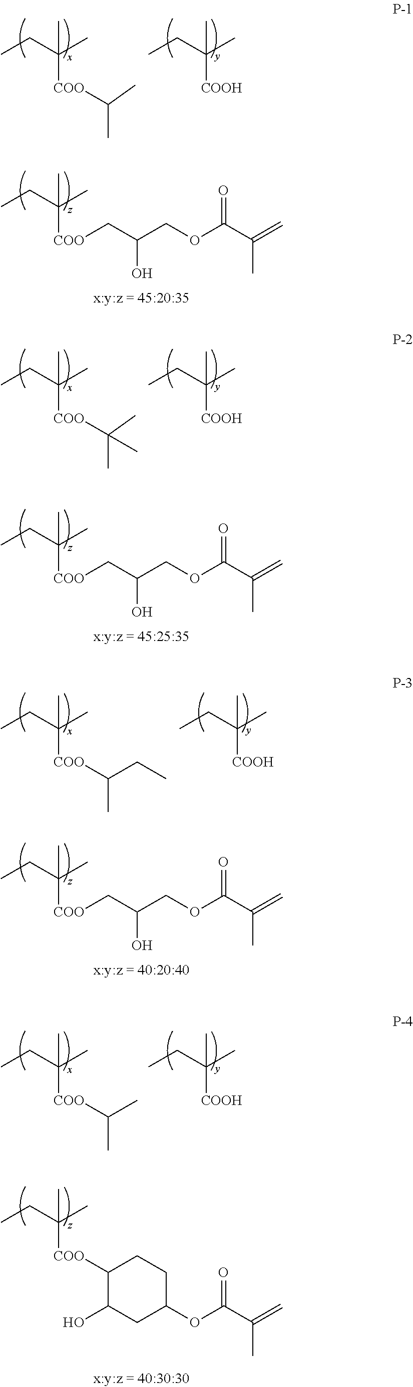

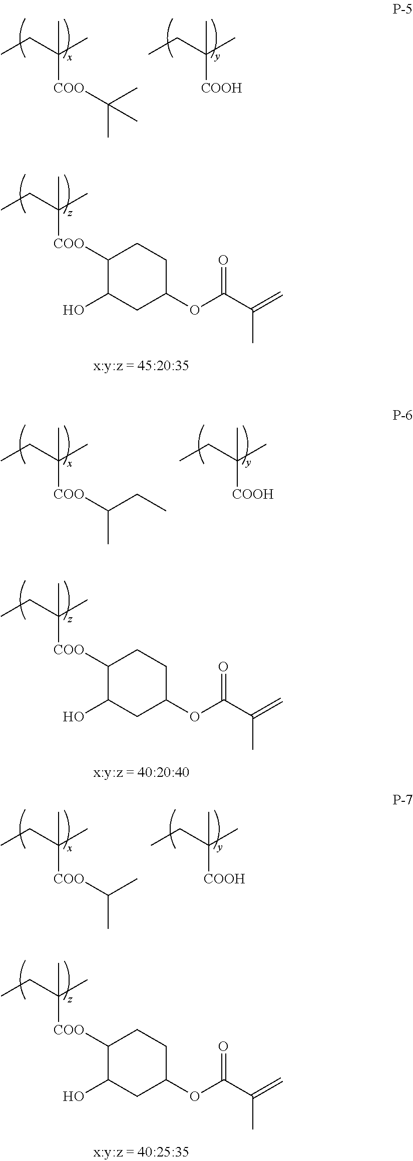

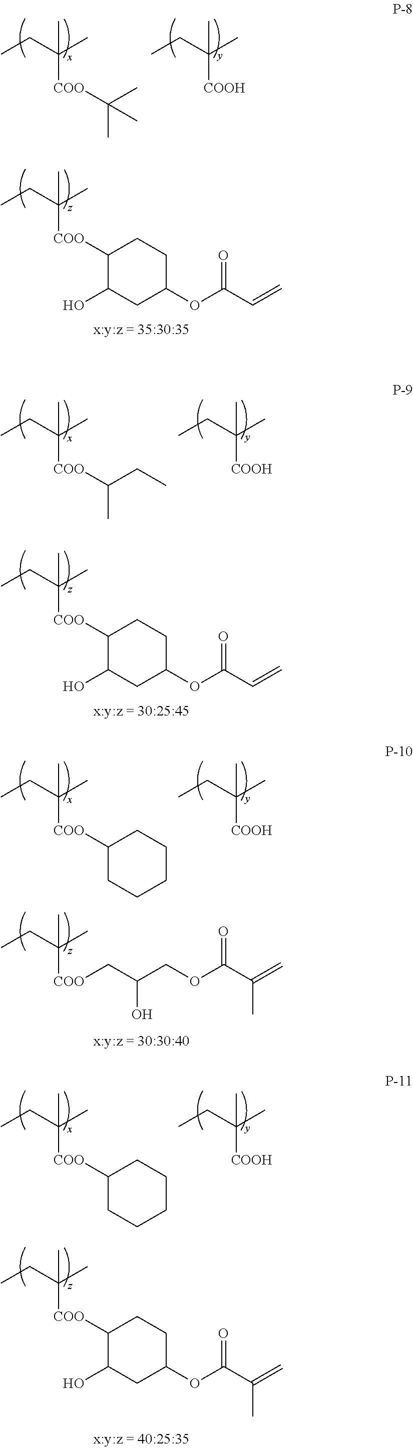

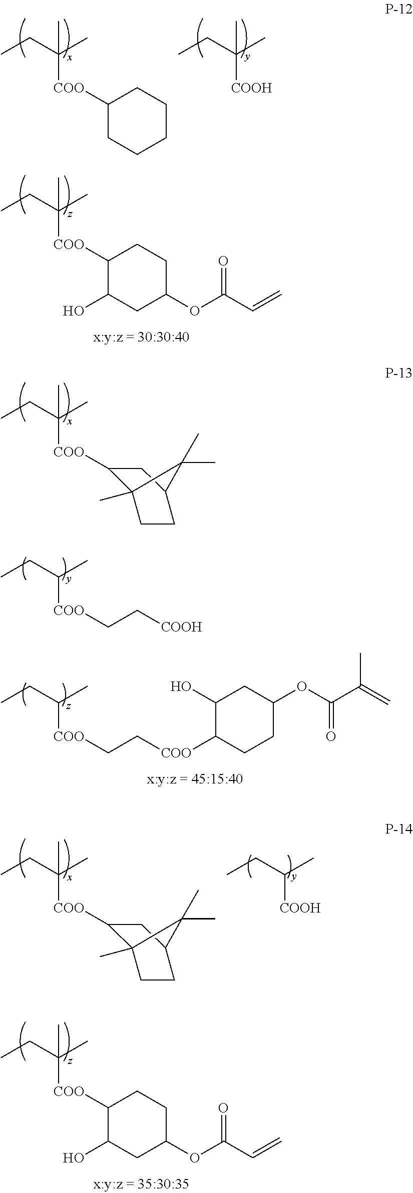

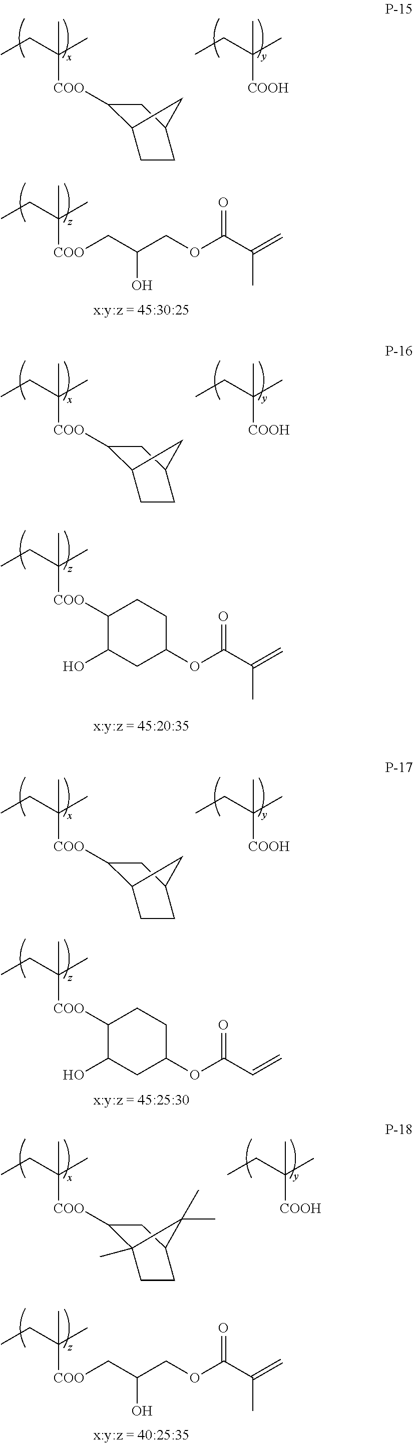

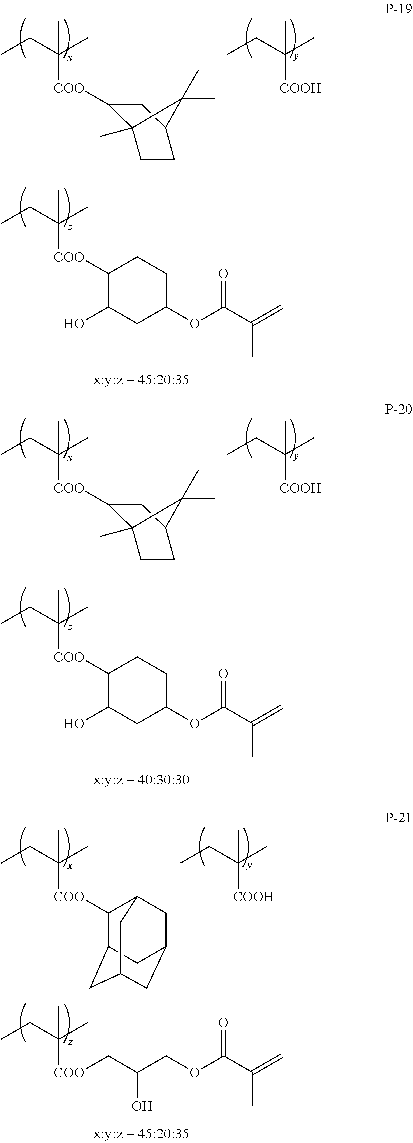

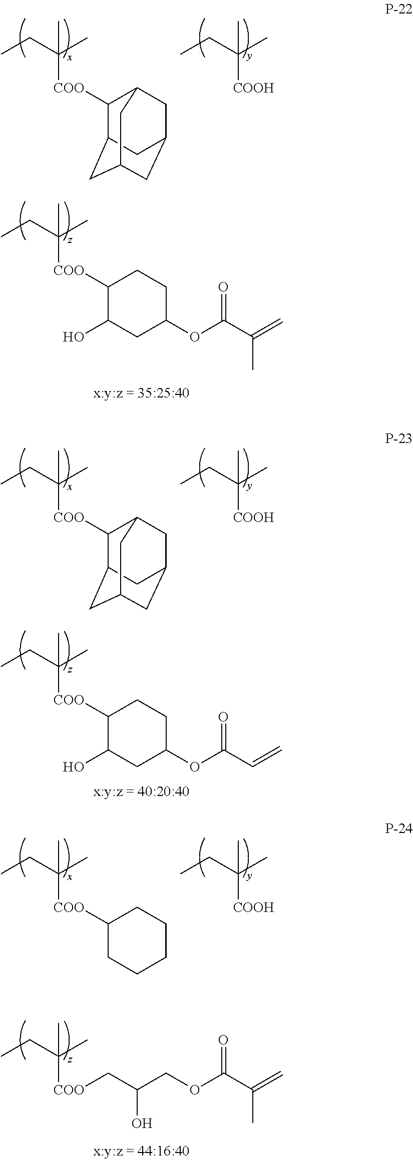

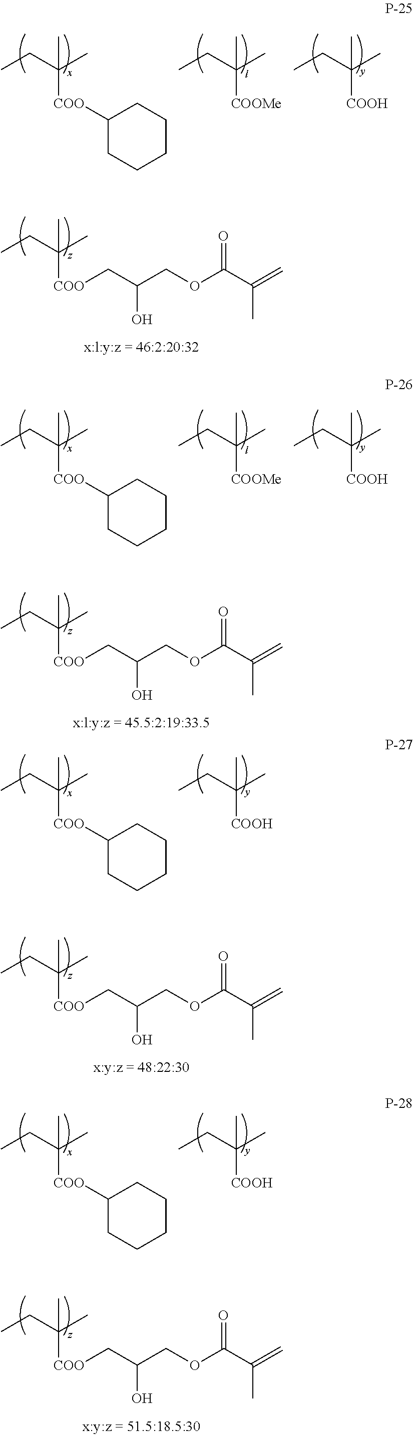

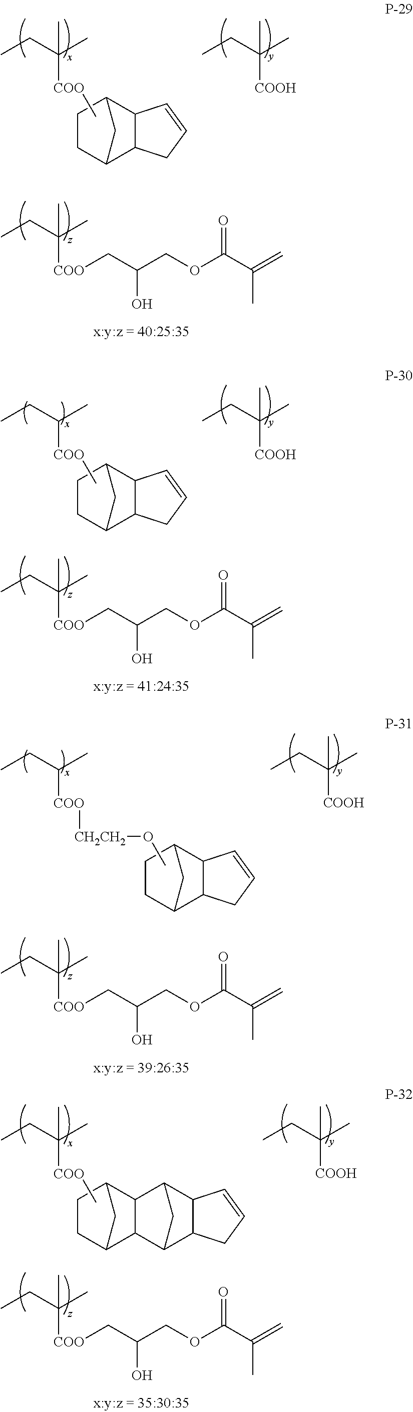

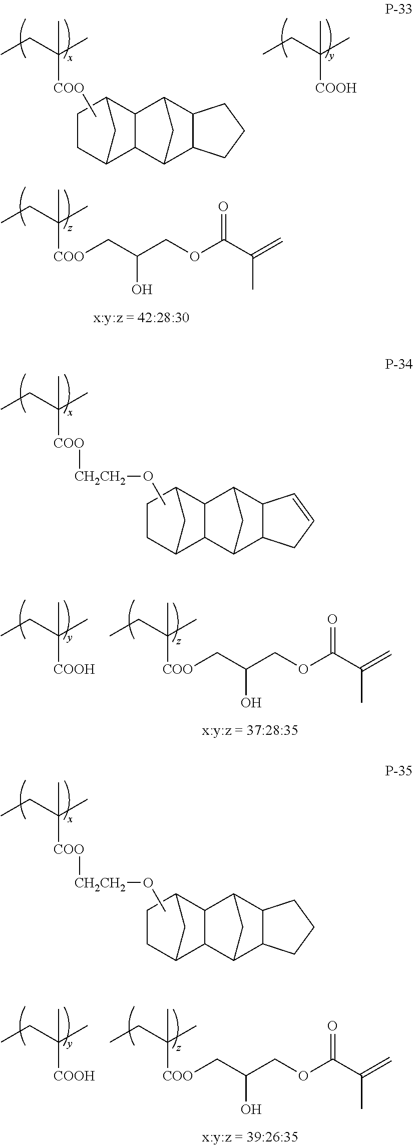

### —Synthesis Method—

The water-insoluble polymer can be synthesized through the following two steps: a step of (co)polymerizing the monomer and a step of introducing an ethylenically unsaturated group.

The (co)polymerization reaction is performed between various monomers. The (co)polymerization reaction is not particularly limited and may be appropriately selected depending on the intended purpose. Examples of the active species for polymerization include radial polymerization, cation polymerization, anion polymerization, and coordination polymerization. Among them, radical polymerization is preferred since it can easily be performed at low cost. Also, the method of the polymerization is not particularly limited and may be appropriately selected from known methods. Examples thereof include a bulk polymerization method, a suspension polymerization method, an emulsion polymerization method, and a solution polymerization method. Among them, a solution polymerization is more preferred.

The weight average molecular weight of the water-insoluble polymer is preferably 10,000 to 100,000, since the water-insoluble polymer having such a weight average molecular weight is easily produced and can give an electroconductive film excellent in electroconductivity, durability and transmittance to lights with long wavelengths. The weight average molecular weight thereof is more preferably 12,000 to 60,000, further preferably 15,000 to 45,000.

The water-insoluble polymer preferably has an acid value of 20 mgKOH/g or higher. When a negative photosensitive resin composition prepared from the electroconductive composition containing the water-insoluble polymer having such an acid value is coated onto a substrate and is then subjected to desired patternwise light exposure and development to thereby form an electroconductive pattern, satisfactory developability can be maintained as well as the obtained electroconductive pattern becomes excellent in electroconductivity, durability and transmittance to lights with long wavelengths.

The acid value is more preferably 50 mgKOH/g or higher, particularly preferably 70 mgKOH/g to 130 mgKOH/g.

A ratio by mass (A/C) of the amount of the electroconductive fibers (A) and the amount of the water-insoluble polymer (C) is preferably 0.2 to 3, more preferably 0.5 to 2.5.

When the ratio by mass (A/C) is less than 0.2, an effect of a dissolution liquid of the present invention may be deteriorated in the case which an unevenness in the resistance value resulting from fluctuations in coating amounts is problematic. When the ratio by mass (A/C) is more than 3, practically sufficient coating film strength cannot be obtained in some cases.

The amount of the electroconductive fibers contained (coating amount) is preferably 0.005 g/m² to 0.5 g/m², more preferably 0.01 g/m² to 0.45 g/m², further preferably 0.015 g/m² to 0.4 g/m².

### <Other Ingredients>

Examples of the other ingredients include various additives such as a dispersing agent, a surfactant, an antioxidant, a sulfurization inhibitor, a metal corrosion inhibitor, a viscosity adjuster and an antiseptic agent, if necessary.

### —Dispersing Agent—

The dispersing agent is used to prevent the electroconductive fibers from being aggregated to allow them to be dispersed. The dispersing agent is not particularly limited, so long as it can disperse the electroconductive fibers, and may be appropriately selected depending on the intended purpose. For example, commercially available low-molecular-weight pigment dispersing agents and polymeric pigment dispersing agents can be used. Among them, preferred are polymeric dispersing agents having adsorbability onto the electroconductive fibers. Examples thereof include polyvinylpyrrolidone, BYK series (products of BYK Chemie), SOLSPERSE series (products of Nippon Lubrizol Corporation) and AJISPER series (product of Ajinomoto Co., Inc.).

The amount of the dispersing agent contained is preferably 0.1 parts by mass to 50 parts by mass, more preferably 0.5 parts by mass to 40 parts by mass, further preferably 1 part by mass to 30 parts by mass, per 100 parts by mass of the polymer. When the amount is less than 0.1 parts by mass, the electroconductive fibers may aggregate in a dispersing liquid. When the amount is more than 50 parts by mass, a stable coating film may not be formed in a coating step, which may cause an uneven coating.

### <Electroconductor>

The electroconductor has a support and the electroconductive film of the present invention provided on the support.

The electroconductor has the support and the electroconductive film of the present invention provided on the support; and, if necessary, further has other members.

The electroconductive film is needed to be made using the electroconductive film of the present invention.

The electroconductor is flexible, and preferably is transparent. The term “transparent” includes colorless and transparent, as well as colored and transparent, semitransparent, and colored and semitransparent.

The electroconductor may be further improved in the light resistance by bonding at least one outermost surface thereof with, for example, a plastic film such as a PET film, a ultraviolet light (UV)-absorbing or -reflecting PET film (UV-PET) which contains or is coated with a UV-absorbing or -reflecting agent, a PET film with a barrier function (barrier film) i.e., a film with low oxygen- and water-permeability, a UV barrier film which is a barrier film further having the UV-absorbing or -reflecting function, or a multilayered film which includes, for example, a UV-PET and a barrier film.

### —Support—

The support is not particularly limited and may be appropriately selected depending on the intended purpose. Examples thereof include transparent glass substrates, synthetic resin sheets and films, metal substrates, ceramic plates and semiconductor substrates having photoelectric conversion elements. These substrates may be pre-treated, as desired, through, for example, a chemical treatment using a silane coupling agent, a plasma treatment, ion plating, sputtering, a vapor phase reaction method, and vacuum vapor deposition.

Examples of the transparent glass substrates include white plate glasses, blue plate glasses and silica-coated blue glasses.

Examples of the synthetic resin sheets and films include those made of, for example, PETs, polycarbonates, polyethersulfones, polyesters, acrylic resins, vinyl chloride resins, aromatic polyamide resins, polyamideimides and polyimides.

Examples of the metal substrates include aluminum plates, copper plates, nickel plates and stainless steel plates.

The support preferably has a total visible light transmittance of 70% or higher, more preferably 85% or higher, particularly preferably 90% or higher.

When the total visible light transmittance is lower than 70%, the transmittance of the support is low, which may be problematic in practical use. Notably, in the present invention, the support may also be a colored support which is colored to such an extent that the effects of the present invention are not impeded.

The thickness of the support is preferably 1 μm to 5,000 more preferably 3 μm to 4,000 μm, particularly preferably 5 μm to 3,000 μm.

When the thickness thereof is smaller than 1 the yield may decrease due to difficulties in handling at the coating step. Whereas when the thickness thereof is greater than 5,000 μm, the thickness and mass of the support may be problematic in use for portable devices.

### <Production Method of Electroconductor>

The production method of the electroconductor includes a step of forming an electroconductive layer and a step of coating the electroconductive layer with a dissolution liquid; and, if necessary, further includes other steps.

### <Step of Forming Electroconductive Layer>

The step of forming the electroconductive layer is a step of coating a support with an electroconductive layer composition containing the electroconductive fibers and the polymer to thereby form the electroconductive layer.

The support, the electroconductive fibers, and the polymer may be appropriately selected from those above-mentioned.

The method for coating the support with the electroconductive layer composition is not particularly limited and may be appropriately selected depending on the intended purpose. Example thereof is a method in which the electroconductive layer composition is coated onto the support by known methods such as spin coating, roll coating or slit coating.

The coating amount (contained amount) of the electroconductive fibers is not particularly limited and may be appropriately selected depending on the intended purpose, and is preferably 0.005 g/m² to 0.5 g/m², more preferably 0.01 g/m² to 0.45 g/m², further preferably 0.015 g/m² to 0.4 g/m².

When the coating amount of the electroconductive fibers is less than 0.005 g/m², the resistance becomes locally high to potentially impair the in-plane distribution of resistance. Whereas when the coating amount of the electroconductive fibers is more than 0.5 g/m², the electroconductive fibers aggregate together during drying after coating, potentially leading to degradation in haze.

The thickness of the electroconductive layer is preferably 20 nm to 5,000 nm, more preferably 25 nm to 4,000 nm, further preferably 30 nm to 3,500 nm.

When the thickness of the electroconductive layer is smaller than 20 nm, the thickness thereof is nearly equal to the average minor axis length of the electroconductive fibers to potentially degrade the film strength of the layer. Whereas when the thickness of the electroconductive layer is greater than 5,000 nm, cracks of the film may occur and the transmittance and haze may be degraded.

The amount of the halogen elements can be controlled in the step of forming the electroconductive layer. Examples of a method for controlling the amount of the halogen elements include (1) a method in which a coating liquid for forming an electroconductive layer are subjected to ultrafiltration, (2) a method in which a solvent such as pure water are added to a coating liquid for forming an electroconductive layer, and then the resultant solution are repeatedly cleaned by subjecting to centrifugation and removing the resultant supernatant, and (3) a method in which an electroconductive layer are formed followed by washing it (for example, by immersing in a washing solvent such as pure water).

<Step of Coating with Dissolution Liquid>

The step of coating the electroconductive layer with the dissolution liquid which dissolves or cleaves electroconductive fibers is a step of patternwise coating the surface of the electroconductive layer with the dissolution liquid which dissolves or cleaves the electroconductive fibers.

The dissolution liquid which dissolves or cleaves electroconductive fibers is patternwise coated onto the electroconductive layer, resulting in non-electroconductive parts which are coated with the dissolution liquid.

—Dissolution Liquid which Dissolves or Cleaves Electroconductive Fibers—

The dissolution liquid which dissolves or cleaves the electroconductive fibers is not particularly limited and may be appropriately selected depending on the intended purpose so long as it can dissolve the electroconductive fibers to thereby form non-electroconductive parts. In the case that the electroconductive fibers are silver nanowires, examples thereof include a bleaching-fixing liquid mainly used in a bleaching-fixing step of printing papers made from silver halide color photosensitive material in a so-called photoscience industry, strong acids such as dilute nitric acid, a oxidizing agent-containing solution, and hydrogen peroxide water. Among them, preferred are a bleaching-fixing liquid, a dilute nitric acid-containing solution, and hydrogen peroxide water, and particularly preferred is a bleaching-fixing liquid. Notably, the electroconductive fibers (preferably silver nanowires) may not be completely dissolved or cut with the dissolution liquid in the dissolution liquid-coated region so long as electroconductivity is eliminated.

The concentration of dilute nitric acid in the dilute nitric acid-containing solution is preferably 1% by mass to 20% by mass.

The concentration of hydrogen peroxide in hydrogen peroxide water is preferably 3% by mass to 30% by mass.

The bleaching-fixing liquid contains a bleaching agent, a fixing agent as well as a bleach-accelerating agent, a rehalogenating agent, a preservative; and, if necessary, further contains other ingredients.

The bleaching agent used in the bleaching-fixing liquid is not particularly limited and may be any bleaching agent. Examples thereof include organic complex salts of iron(III) (e.g., aminopolycarboxylic acids such as ethylenediamine tetraacetic acid and diethylenetriamine pentaacetic acid; aminopolyphosphonic acids, phosphonocarboxylic acids and organic phosphonic acids); or organic acids such as citric acid, tartaric acid and malic acid; persulfates; hydrogen peroxide.

Among them, particularly preferred is organic complex salts of iron(III) from the viewpoint of a rapid patterning treatment and an environmental pollution control. The amount of organic complex salts of iron(III) per 1 liter is preferably 0.05 mol to 3 mol, more preferably 0.1 mol to 1.5 mol.

Examples of the aminopolycarboxylic acids, aminopolyphosphonic acids or organic phosphonic acids or salts thereof useful for forming the organic complex salts of iron(III) include ethylenediamine tetraacetic acid, diethylenetriamine pentaacetic acid, 1,3-diaminopropane tetraacetic acid, propylenediamine tetraacetic acid, nitrilotriacetic acid, cyclohexanediamine tetraacetic acid, methyliminodiacetic acid, iminodiacetic acid and glycoletherdiamine tetraacetic acid. These compounds may be either of sodium, potassium, lithium or ammonium salts. Among them, preferred are complex salts of iron(III) with ethylenediamine tetraacetic acid, diethylenetriamine pentaacetic acid, cyclohexanediamine tetraacetic acid, 1,3-diaminopropane tetraacetic acid and methyliminodiacetic acid from the viewpoint of their high bleaching ability.

These complex salts of ferric ion may be used in form of complex salts or may be formed by reacting, in a solution, ferric salts such as ferric sulfate, ferric chloride, ferric nitrate, ferric ammonium sulfate or ferric phosphate with a chelating agent such as aminopolycarboxylic acids, aminopolyphosphonic acids or phosphonocarboxylic acids. In the latter case, the chelating agent may be used in excess amount greater than the stoichiometric amount. Preferred is a ferric complex of aminopolycarboxylic acids, and the amount thereof to be added is preferably 0.01 mol/L to 1.0 mol/L, more preferably 0.005 mol/L to 0.50 mol/L.

The fixing agent used in the bleaching-fixing liquid is not particularly limited and may be appropriately selected from any known fixing agents. Examples thereof include water-soluble silver halide solubilizing agents such as thiosulfates (e.g., sodium thiosulfate and ammonium thiosulfate); thiocyanate (e.g., sodium thiocyanate and ammonium thiocyanate); thioether compounds (e.g., ethylene-bis-thioglycolic acid and 3,6-dithia-1,8-octanediol); and thioureas. These may be used alone or in combination. Moreover, it is also possible to use a specific bleaching-fixing liquid containing a combination of a fixing agent with a large amount of halides such as potassium iodide as disclosed in JP-A No. 55-155354. Among them, preferred is thiosulfates, and particularly preferred is ammonium thiosulfate. The amount of the fixing agent used is preferably 0.3 mol/L to 2 mol/L, more preferably 0.5 mol/L to 1.0 mol/L.

The bleaching-fixing liquid may contain various compounds as a bleach-accelerating agent. Examples thereof include compounds having a mercapto group or a disulfide bond disclosed in U.S. Pat. No. 3,893,858, German Patent No. 1,290,812, JP-A No. 53-95630 and Research Disclosure No. 17129 (July, 1978); thiourea compounds disclosed in Japanese patent Application Publication (JP-B) No. 45-8506, JP-A Nos. 52-20832 and 53-32735 and U.S. Pat. No. 3,706,561; or halides such as iodides or bromides.

The bleaching-fixing liquid may contain rehalogenating agents such as bromides (e.g., potassium bromide, sodium bromide and ammonium bromide); chlorides (e.g., potassium chloride, sodium chloride and ammonium chloride); or iodides (e.g., ammonium iodide), if necessary.

The bleaching-fixing liquid may contain, as preservatives, sulfite ion-releasing compounds such as sulfites (e.g., sodium sulfite, potassium sulfite and ammonium sulfite); bisulfites (e.g., ammonium bisulfite, sodium bisulfite and potassium bisulfite); and metabisulfites (e.g., potassium metabisulfite, sodium metabisulfite and ammonium metabisulfite). The amount of these compounds contained is preferably about 0.02 mol/L to about 0.50 mol/L, more preferably 0.04 mol/L to 0.40 mol/L in terms of sulfite ions. Among them, ammonium sulfite is particularly preferred.

Sulfites are generally used as the preservatives, but other preservatives can be used such as ascorbic acid, carbonyl/bisulfite adducts, sulfinic acids, carbonyl compounds, or sulfuric acids.

The pH value of the bleaching-fixing liquid is preferably 8 or less, more preferably 3 to 8, further preferably 4 to 7, particularly preferably 5.7 to 6.5. When the pH is lower than the above range, the electroconductive fibers is improved in dissolvability, but the dissolution liquid may be quickly deteriorated. When the pH is higher than the above range, the time needed to dissolve the electroconductive fibers is prolonged, which may deteriorate the resolution upon patterning.

In order to adjust the pH value, for example, hydrochloric acid, sulfuric acid, nitric acid, acetic acid, bicarbonates, ammonia, potassium hydroxide, sodium hydroxide, sodium carbonate or potassium can be added, if necessary.

The bleaching-fixing liquid may, if necessary, further contain other ingredients such as one or more inorganic acids, organic acids, or alkali metal or ammonium salts thereof having pH buffering ability such as boric acid, borax, sodium metaborate, acetic acid, sodium acetate, sodium carbonate, potassium carbonate, phosphorous acid, phosphoric acid, sodium phosphate, citric acid, sodium citrate and tartaric acid; anticorrosive agents such as ammonium nitrate and guanidine; buffering agents, fluorescent whiteners, chelating agents, antifungal agents, various fluorescent whiteners, antifoaming agents, surfactants, polyvinylpyrrolidone, organic solvents such as methanol.

The bleaching-fixing liquid may be appropriately prepared or may be commercial products. Examples of the commercial products include CP-48S, CP-49E (bleaching-fixing liquids for color papers; all products of FUJIFILM Corporation), EKTACOLOR RA bleaching-fixing liquid (product of Kodak Co., Ltd.), D-J2P-02-P2, D-30P2R-01, D-22P2R-01 bleaching-fixing liquids (all products of Dai Nippon Printing Co., Ltd.) Among them, CP-48S and CP-49E are particularly preferred.

The time for bleaching-fixing is preferably 180 sec or less, more preferably 1 sec to 120 sec, further preferably 5 sec to 90 sec. The time for washing with water or stabilizing is preferably 180 sec or less, more preferably 1 sec to 120 sec.

The washing with water or stabilizing treatment may be performed by immersing the electroconductive layers in water or a stabilizing liquid, but, taking into account that electroconductive fiber-containing layers are very thin and have relatively weak film strength, more preferably performed by showering water or a stabilizing liquid to the electroconductive layers from the viewpoint of high washing efficiency.

The viscosity of the dissolution liquid which dissolves or cut the electroconductive fibers is varies depending on patterning methods described below, but is preferably 5 mPa·s to 300,000 mPa·s, more preferably 10 mPa·s to 150,000 mPa·s at 25° C. When the viscosity is less than 5 mPa·s, depending on printing methods, the dissolution liquid may spread over an undesired area, which may make it difficult to form a well-defined pattern. When the viscosity is more than 300,000 mPa·s, depending on printing methods, loads are applied to the process, which may prolong the process time.

The viscosity can be measured with, for example, the Brookfield viscometer.

The viscosity of the dissolution liquid can be adjusted to fall within the above range by adding a thickening agent to the dissolution liquid. Examples of the thickening agent include ARON A-20L (product of TOAGOSEI CO., LTD.), gelatin, water-soluble cellulose, and glycerin.

A method in which the dissolution liquid which dissolves or cleaves the electroconductive fibers is patternwise coated (patterning method) is not particularly limited and may be appropriately selected depending on the intended purpose, so long as the dissolution liquid can be patternwise coated. Examples thereof include a screen printing method, an inkjet printing method, and a method in which a etching mask is previously formed with resist, followed by coating the dissolution liquid thereon through, for example, coater coating, roller coating, dipping coating, or spray coating. Among them, preferred are the screen printing method, the inkjet printing method, the coater coating method, and the dip (immersing) coating method, and particularly preferred are the screen printing method and the inkjet printing method.

The screen printing method is a method in which a pattern is formed on an electroconductive film serving as a printed substrate via a screen printing plate having a number of desired-shaped pores. At first, the screen printing plate is placed on the electroconductive film with a clearance, and then the dissolution liquid is supplied on the screen printing plate. Next, a squeegee is moved on the screen printing plate with pushing down it so that the screen printing plate is made contact with the electroconductive film. Along with the moving of the squeegee, the dissolution liquid passes through openings of the screen printing plate and comes into contact with the underlying electroconductive film to thereby being transferred to the electroconductive film.

In the screen printing method, the viscosity of the dissolution liquid is preferably 10,000 mPa·s to 300,000 mPa·s, more preferably 15,000 mPa·s to 150,000 mPa·s, further preferably 20,000 to 70,000 mPa·s at 25° C.

When the viscosity is less than 10,000 mPa·s, the dissolution liquid may spread over an undesired area, which may make the pattern unclear. When the viscosity is more than 300,000 mPa·s, the dissolution liquid may be remained on the electroconductive film even after the water-washing or stabilizing treatment.

The inkjet printing method is a method in which the dissolution liquid which dissolves or cleaves the electroconductive fibers is patternwise discharged on the electroconductive film. In this method, a piezo mode or a thermal mode may be used.

In the inkjet printing method, the viscosity of the dissolution liquid is preferably 1 mPa·s to 200 mPa·s, more preferably 5 mPa·s to 100 mPa·s, further preferably 10 mPa·s to 50 mPa·s at 25° C.

When the viscosity is less than 1 mPa·s, the dissolution liquid may spread over and wet an undesired area after an ink is landed on the electroconductive film, which may make the pattern unclear. When the viscosity is more than 200 mPa·s, more energy may be required to discharge an ink and an ink may be unstably discharged due to a dirty inkjet head.

The type of the pattern is not particularly limited and may be appropriately selected depending on the intended purpose. Examples thereof include characters, symbols, designs, figures, and wiring patterns.

The size of the pattern is not particularly limited and may be appropriately selected depending on the intended purpose. The size may be any size ranging from nanometers to millimeters.

The surface resistance on the non-electroconductive parts which is coated with the dissolution liquid is preferably 5 kΩ/sq. or more, more preferably 100 kΩ/sq. or more, further preferably 1 MΩ/sq. or more. The upper limit of the surface resistance is preferably 10⁹ Ω/sq. or less.

The surface resistance on the electroconductive parts (electroconductive film) which is not coated with the dissolution liquid is preferably less than 5 kΩ/sq., more preferably less than 500 kΩ/sq. The lower limit of the surface resistance is preferably 1 Ω/sq. or more.

The surface resistance can be measured with a surface resistance meter (LORESTA-GP MCP-T600; product of Mitsubishi Chemical Corporation).

The electroconductive film of the present invention has the total light transmittance of preferably 70% or more, more preferably 80% or more.

The total light transmittance can be measured with HAZE-GARD PLUS (product of Gardner Co., Ltd.).

The electroconductive film of the present invention has significantly improved insulating property, high transmittance, low resistance, and improved durability and flexibility, and can be easily patterned, and thus, can be widely coated for a touch panel, a display electrode, an electromagnetic shield, an organic or inorganic EL display electrode, an electronic paper electrode, a flexible display electrode, a solar battery electrode, a display device electrode, and other various devices. Among them, particularly preferred are the touch panel, the display device electrode, and the solar battery electrode.

### <Display Element>

A liquid crystal display element as a display element used in the present invention is made of an element substrate having the electroconductor patterned in the above-described manner and a color filter substrate serving as a counter substrate. Specifically, these substrates are positioned and pressure-bonded to each other, followed by being assembled through thermal treatment. Then, liquid crystals are injected thereinto and finally, the inlet from which liquid crystals are injected is sealed. Preferably, an electroconductor formed on the color filter is also formed of the electroconductor.

Alternatively, the liquid crystal display element can be made using a method in which liquid crystals are spread on the element substrate, thereafter a substrate is superposed on the element substrate and the resultant structure is sealed so that liquid crystals can not leak out.

Notably, liquid crystals (i.e., liquid crystal compounds and liquid crystal compositions) used in the liquid crystal display element are not particularly limited, and any liquid crystal compounds and liquid crystal compositions can be used.

### (Touch Panel)

The touch panel of the present invention is not particularly limited and may be appropriately selected depending on the intended purpose, so long as it has the electroconductor including the electroconductive film of the present invention.

Examples of the touch panel include a surface capacitive touch panel, a project capacitive touch panel and a resistive touch panel. Notably, the touch panel encompasses so-called touch sensors and touch pads.

The electrode parts of the touch panel sensor in the touch panel preferably has any of the following layer constructions: a bonding type in which two transparent electrodes are bonded together, a type in which transparent electrodes are provided on both sides of one substrate, a one-side jumper type, a through-hole type, or a one-side lamination type.

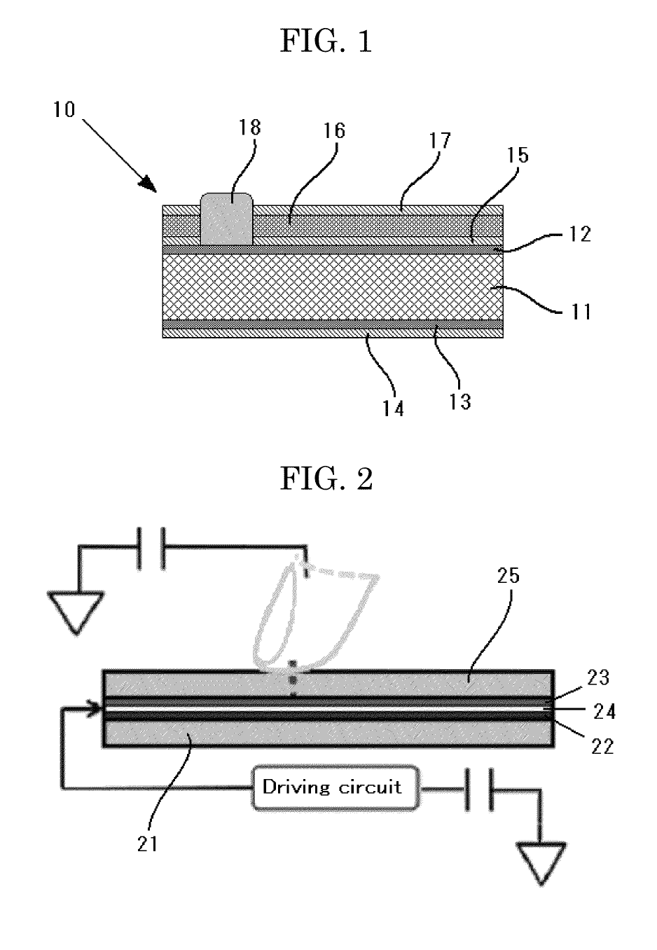

One example of the surface capacitive touch panel will be described with reference to FIG. 1. In FIG. 1, a touch panel 10 includes a transparent substrate 11, a transparent electroconductor 12 disposed so as to uniformly cover the surface of the transparent substrate 11, and an electrode terminal 18 for electrical connection with an external detection circuit (not shown), where the electrode terminal 18 is formed on the transparent electroconductor 12 at the end of the transparent substrate 11.

Notably, in this figure, reference numeral 13 denotes a transparent electroconductor serving as a shield electrode, reference numeral 14 or 17 denotes a protective film, reference numeral 15 denotes an intermediate protective film, and reference numeral 16 denotes an antiglare layer.

For example, when touching any point on the transparent electroconductor 12 with a finger, the transparent electroconductor 12 is connected at the touched point to ground via the human body, which causes a change in resistance between the electrode terminal 18 and the grounding line. The change in resistance therebetween is detected by the external detection circuit, whereby the coordinate of the touched point is identified.

Another example of the surface capacitive touch panel will be described with reference to FIG. 2. In FIG. 2, a touch panel 20 includes a transparent substrate 21, a transparent electroconductor 22, a transparent electroconductor 23, an insulating layer 24 and an insulating cover layer 25, where the transparent electroconductor 22 and the transparent electroconductor 23 are disposed so as to cover the surface of the transparent substrate 21. The insulating layer 24 insulates the transparent electroconductor 22 from the transparent electroconductor 23. The insulating cover layer 25 creates capacitance between the transparent electroconductor 22 or 23 and a contact object such as a finger coming into contact with the touch panel. In this touch panel, the position of the contact object such as the finger coming into contact with the touch panel is detected. Depending on the intended configuration, the transparent electroconductors 22 and 23 may be formed as a single member and also, the insulating layer 24 or the insulating cover layer 25 may be formed as an air layer.

When touching the insulating cover layer 25 with contact object such as the finger, a change in capacitance is caused between the contact object such as the finger and the transparent electroconductor 22 or the transparent electroconductor 23. The change in capacitance therebetween is detected by the external detection circuit, whereby the coordinate of the touched point is identified.

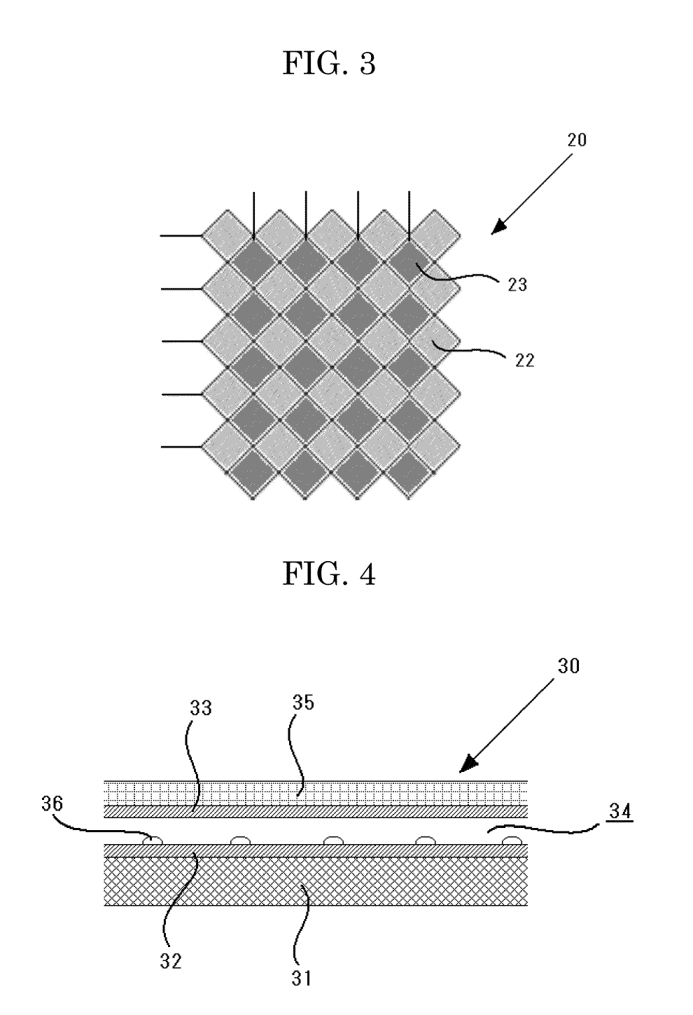

Also, a touch panel 20 as a project capacitive touch panel will be schematically described with reference to FIG. 3 which is a plan view of the arrangement of transparent electroconductors 22 and transparent electroconductors 23.

The touch panel 20 includes a plurality of the transparent electroconductors 22 capable of detecting the position in the X axis direction and a plurality of the transparent electroconductors 23 arranged in the Y axis direction, where these transparent electroconductors 22 and 23 are disposed so that they can be connected with external terminals. A plurality of the transparent electroconductors 22 and 23 come into contact with the contact object such as the finger, whereby contact information can be input at a plurality of points.

For example, when touching any point on the touch panel 20 with a finger, the coordinates in the X axis direction and the Y axis direction are indentified with high positional accuracy.

Notably, the other members such as a transparent substrate and a protective layer may be appropriately selected from the members of the surface capacitive touch panel. Also, the above-described pattern of the transparent electroconductors containing the transparent electroconductors 22 and 23 in the touch panel 20 is non-limiting example, and thus, for example, the shape and arrangement are not limited thereto.

One example of the resistive touch panel will be described with reference to FIG. 4. In FIG. 4, a touch panel 30 includes a transparent electroconductor 32, a substrate 31, a plurality of spacers 36, an air layer 34, a transparent electroconductor 33 and a transparent film 35, where the transparent electroconductor 32 is disposed on the substrate 31, the spacers 36 are disposed on the transparent electroconductor 32, the transparent electroconductor 33 can come into contact via the air layer 34 with the transparent electroconductor 32, and the transparent film 35 is disposed on the transparent electroconductor 33. These members are supported in this touch panel.

When touching the touch panel 30 from the side of the transparent film 35, the transparent film 35 is pressed and the pressed transparent electroconductor 32 and the pressed transparent electroconductor 33 come into contact with each other.

A change in voltage at this point is detected with an external detection circuit (not shown), whereby the coordinate of the touched point is indentified.

### (Solar Battery)

The solar battery is made using the electroconductive film of the present invention.

The solar battery (hereinafter may be referred to as “solar battery device”) is not particularly limited and may be the ones commonly used as a solar battery device. Examples of the solar battery include a single crystal silicon solar battery device, polycrystalline silicon solar battery device, an amorphous silicon solar battery device of a single junction or tandem structure, a III-V group compound semiconductor solar battery device using, for example, gallium arsenide (GaAs) and indium phosphide (InP), a II-VI group compound semiconductor solar battery device using, for example, cadmium tellurium (CdTe), a I-III-VI group compound semiconductor solar battery device of copper/indium/selenium type (so-called, CIS type), copper/indium/gallium/selenium type (so-called, CIGS type), or copper/indium/gallium/selenium/sulfur type (so-called, CIGSS type), a dye-sensitized solar battery device, and an organic solar battery device. Among them, in the present invention, the solar battery device is preferably the amorphous silicon solar battery device of a tandem structure, and the I-III-VI group compound semiconductor solar battery device of copper/indium/selenium type (so-called, CIS type), copper/indium/gallium/selenium type (so-called, CIGS type), or copper/indium/gallium/selenium/sulfur type (so-called, CIGSS type).

In the case of the amorphous silicon solar battery device of, for example, a tandem structure, amorphous silicon, a microcrystal silicon thin layer, a thin layer formed by adding germanium to the amorphous silicon or the microcrystal silicon thin layer, or a tandem structure of two or more layers selected therefrom is used as a photoelectric conversion layer. For the formation of the layer, for example, a plasma chemical vapor deposition (PCVD) is used.

### EXAMPLES

The present invention will next be described by way of examples, which should not be construed as limiting the present invention thereto.

### Preparation Example 1

### Preparation of Water-Insoluble Polymer (1)

A reaction container was charged in advance with 8.57 parts of 1-methoxy-2-propanol (MMPGAC, product of DAICEL CHEMICAL INDUSTRIES, LTD.), followed by heating to 90° C. Cyclohexylmethacrylate, methylmethacrylate, and methacrylic acid (the amounts of cyclohexylmethacrylate, methylmethacrylate, methacrylic acid and below-described glycidyl methacrylate added were adjusted so as to have a mass ratio of 45.5 mol %:2 mol %:19 mol %:33.5 mol %, respectively) (serving as monomers), an azo-based polymerization initiator (product of Wako Pure Chemical Industries, Ltd., V-601) (1 part by mass) and 1-methoxy-2-propanol (8.57 parts by mass) were mixed together to prepare a mixed solution. Then, in a nitrogen gas atmosphere, the thus-prepared mixed solution was added dropwise to the reaction container at 90° C. for 2 hours. After completion of the dropwise addition, the resultant mixture was allowed to react for 4 hours to obtain an acryl resin solution.

Next, hydroquinone monomethyl ether (0.025 parts by mass) and tetraethylammonium bromide (0.084 parts by mass) were added to the thus-obtained acryl resin solution. Thereafter, glycidyl methacrylate was added dropwise to the resultant mixture for 2 hours. After completion of the dropwise addition, the resultant mixture was allowed to react at 90° C. for 4 hours while feeding air thereto. Then, a solvent was added to the mixture so that the concentration of the solid amount therein was adjusted to 45% by mass, to thereby obtain a solution of water-insoluble polymer (1) having a unsaturated group (weight average molecular mass (Mw): 30,000, 45% by mass 1-methoxy-2-propanol solution).

Notably, the weight average molecular weight was measured with gel permeation chromatograph (GPC).

The SP value of the water-insoluble polymer (1) was calculated by the Okitsu method and was found to be 22 MPa^{1/2}.

### Preparation Example 2

### Preparation of Silver Nanowire Dispersion (1

Silver nitrate powder (0.51 g) was dissolved in pure water (50 mL) to prepare a silver nitrate solution. Then, 1N aqueous ammonia was added thereto until the silver nitrate solution became transparent. In addition, pure water was added to the resultant solution so that the total volume was adjusted to 100 mL, whereby additive liquid A was prepared.

Separately, glucose powder (0.5 g) was dissolved in pure water (140 mL) to prepare additive liquid G.

Furthermore, HTAB (hexadecyl-trimethylammonium bromide) powder (0.5 g) was dissolved in pure water (27.5 mL) to prepare additive liquid H.

The additive liquid A (20.6 mL) was added to a three-neck flask and stirred at room temperature. Then, pure water (41 mL), the additive liquid H (20.6 mL) and the additive liquid G (16.5 mL) were added thereto through a funnel in this order. The resultant mixture was heated at 90° C. for 5 hours under stirring at 200 rpm to obtain a dispersion.

The thus-obtained dispersion was cooled and polyvinylpyrrolidone (K-30, product of Wako Pure Chemical Industries, Ltd.) was added thereto under stirring so that the amount of polyvinylpyrrolidone added was 0.05 relative to 1 of the silver (in mass ratio). Then, the resultant dispersion was centrifuged and purified until the conductivity thereof reached a value of 150 μS/cm or lower. The resultant dispersion was further centrifuged using propylene glycol monomethyl ether to remove water. Finally, propylene glycol monomethyl ether was added thereto to thereby prepare silver nanowire dispersion (1).

The obtained silver nanowire dispersion (1) was measured as follows for average minor axis length, average major axis length, variation coefficient of minor axis lengths, and ratio of electroconductive fibers (silver nanowires) having an aspect ratio of 10 or more. The results are shown in Table 1.

### <Average Minor Axis Length and Average Major Axis Length of Metal Nanowires>

Three hundred metal nanowires were observed under a transmission electron microscope (TEM) (product of JEOL Ltd., JEM-2000FX). Based on the average values obtained from the observation, the average minor axis length and the average major axis length of the metal nanowires were obtained.

### <Variation Coefficient of Minor Axis Lengths of Metal Nanowires>

Three hundred metal nanowires were observed for their minor axis lengths under a transmission electron microscope (TEM) (product of JEOL Ltd., JEM-2000FX). The variation coefficient of the minor axis lengths was calculated from the standard deviation and the average value of the minor axis lengths.

<Ratio of Electroconductive Fibers having Aspect Ratio of 10 or more>

Each of the silver nanowire dispersions was filtrated to separate the silver nanowires from the other particles, and the amount of silver remaining on the filter and the amount of silver having passed through the filter were respectively measured by means of ICP ATOMIC EMISSION SPECTROMETER (product of Shimadzu Corporation, ICPS-8000), to thereby obtain the amount of the metal nanowires having a minor axis length of 50 nm or less and a major axis length of 5 μm or more as the ratio (%) of the electroconductive fibers having an aspect ratio of 10 or more.

Note that, separation of the metal nanowires was performed using a membrane filter (product of Millipore K.K., FALP 02500, pore size: 1.0 μm) for obtaining the above ratio of the electroconductive fibers.

### Preparation Example 3

### Preparation of Silver Nanowire Dispersion (2)

Ethylene glycol (30 mL) was added to a three-neck flask and heated to 160° C. Then, an ethylene glycol solution (18 mL) containing 36 mM polyvinylpyrrolidone (PVP; K-55, product of Sigma-Aldrich Co. LLC.), 3 μM iron acetylacetonate, 60 μM sodium chloride, and an ethylene glycol solution (18 mL) containing 24 mM silver nitrate were added thereto at 1 mL/min. The resultant mixture was heated at 160° C. for 60 min and then cooled to room temperature. Thereafter, water was added thereto, followed by centrifugation. The mixture was purified until the conductivity reached a value of 150 μS/cm or lower. The resultant dispersion was further centrifuged using propylene glycol monomethyl ether to remove water. Finally, propylene glycol monomethyl ether was added thereto to obtain silver nanowire dispersion (2).

In the same manner as in silver nanowire dispersion (1), the obtained silver nanowire dispersion (2) was measured for average minor axis length, average major axis length, variation coefficient of minor axis lengths, and ratio of electroconductive fibers (silver nanowires) having an aspect ratio of 10 or more The results are shown in Table 1.

TABLE 1

| | | | | Ratio of |
|---|---|---|---|---|
| | Average minor | Average major | | electro- |
| | axis length | axis length | Variation | conductive |
| | (nm) | (μm) | coefficient | fibers |
| Silver nanowire | 23 | 32 | 81.4% | 77.4% |
| dispersion (1) | | | | |
| Silver nanowire | 105 | 42 | 79.4% | 75.1% |
| dispersion (2) | | | | |

* In Table 1, “Ratio of electroconductive fibers” means the ratio of the electroconductive fibers (silver nanowires) having an aspect ratio of 10 or more.

### Example 1

### Production of Transparent Electroconductor

Samples Nos. 101 to 111 shown in Tables 2-1 and 2-2 were produced as follows.

### <Production of Sample No. 101>

### —Formation of Undercoat Layer—

A commercially available heat-treated biaxially drawn polyethylene terephthalate (PET) substrate having a thickness of 100 μm was subjected to a corona discharge treatment at 8 W/m²·min, followed by coating with a coating liquid for an undercoat layer having the following composition to thereby form the undercoat layer having a dry thickness of 0.8 μm.

### —Composition of Coating Liquid for Undercoat Layer—

Butyl actylate: 40% by mass

Styrene: 20% by mass

Glycidylacrylate: 40% by mass

To copolymer latex having the above composition, was added hexamethylene-1,6-bis(ethyleneurea) so as to have a concentration of 0.5% by mass to thereby prepare the coating liquid for the undercoat layer.

Next, the surface of the undercoat layer was subjected to a corona discharge treatment at 8 W/m²·min, followed by coating with hydroxyethyl cellulose as a hydrophilic polymer layer so as to have a density of 0.12 g/m².

Then, the silver nanowire dispersion (1) was coated onto the hydrophilic polymer layer with a doctor coater, followed by drying. The coated amount of silver was measured with a fluorescent X-ray analyzer (SEA1100, product of Seiko Instruments, Inc.), and the coated amount was adjusted to 0.06 g/m² to thereby form an electroconductive layer. The resultant coating film was immersed in pure water at 25° C. for 5 min, followed by ultrasonically washing with an ultrasonic washing device (ASU-2M, product of AS ONE Corporation) in pure water for 2 min and rinsing with pure water twice. Thus, the transparent electroconductor of Sample No. 101 was produced.

For the electroconductive layer (electroconductive film) of the resultant transparent electroconductor of Sample No. 101, the amount of the halogen element was measured with the fluorescent X-ray analyzer (SEA1100, product of Seiko Instruments, Inc.), and was found to be 3,000 ppm by mass. In this measurement, a standard curve for measurement of the amount of the halogen element had been previously generated by coating a mixture aqueous solution (0.1% by mass) containing potassium chloride, potassium bromide, and potassium iodide onto the hydrophilic polymer with varying coating thickness, and plotting the coating amounts versus the detected peak intensities. Then, the peak intensity of Sample No. 101 was measured and fitted into the standard curve to thereby determine the amount of the halogen element.

In addition, for the resultant transparent electroconductor of Sample No. 101, the atomic ratio (X/A) of the amount of silver constituting the silver nanowires in the electroconductive layer (A) and the amount of the halogen element in the electroconductive layer (X) was calculated from the coating amount of silver and the amount of the halogen element and was found to be <0.01.

For dry powder scraped off from the transparent electroconductor of Sample No. 101, the atomic ratio (X/A) was measured with an automatic sample combustion type ion chromatograph (model AQF-100; product of DIA Instruments Co., Ltd.), and was found to be <0.01, which was same as the above value.

<Production of Sample No. 102>

A transparent electroconductor of Sample No. 102 was produced in the same manner as in Sample No. 101, except that the time for immersing in pure water was changed to 2 min and the ultrasonic washing was not performed.

The electroconductive layer in the resultant transparent electroconductor of Sample No. 102 was found to have the amount of the halogen element of 50,000 ppm by mass when measured in the same manner as in Sample No. 101.

The resultant transparent electroconductor of Sample No. 102 was found to have the atomic ratio (X/A) of 0.15 when measured in the same manner as in Sample No. 101.

### <Production of Sample No. 103>

A transparent electroconductor of Sample No. 103 was produced in the same manner as in Sample No. 102, except that the time for immersing in pure water was changed to 30 sec.

The electroconductive layer in the resultant transparent electroconductor of Sample No. 103 was found to have the amount of the halogen element of 160,000 ppm by mass when measured in the same manner as in Sample No. 101.

The resultant transparent electroconductor of Sample No. 103 was found to have the atomic ratio (X/A) of 0.48 when measured in the same manner as in Sample No. 101.

### <Production of Sample No. 104>

A transparent electroconductor of Sample No. 104 was produced in the same manner as in Sample No. 102, except that the immersion in pure water and the rinsing with pure water twice were not performed.

The electroconductive layer in the resultant transparent electroconductor of Sample No. 104 was found to have the amount of the halogen element of 260,000 ppm by mass when measured in the same manner as in Sample No. 101.

The resultant transparent electroconductor of Sample No. 104 was found to have the atomic ratio (X/A) of 0.78 when measured in the same manner as in Sample No. 101.

### <Production of Sample No. 105>

A transparent electroconductor of Sample No. 105 was produced in the same manner as in Sample No. 102, except that, upon immersing in pure water, pure water was changed to a mixture aqueous solution (0.1% by mass) containing potassium chloride, potassium bromide, and potassium iodide and the time for immersing was changed to 45 sec.

The electroconductive layer in the resultant transparent electroconductor of Sample No. 105 was found to have the amount of the halogen element of 420,000 ppm by mass when measured in the same manner as in Sample No. 101.

The resultant transparent electroconductor of Sample No. 105 was found to have the atomic ratio (X/A) of 1.25 when measured in the same manner as in Sample No. 101.

### <Production of Sample No. 106>

A transparent electroconductor of Sample No. 106 was produced in the same manner as in Sample No. 102, except that, upon immersing in pure water, pure water was changed to a mixture aqueous solution (1% by mass) containing potassium chloride, potassium bromide and potassium iodide and the time for immersing was changed to 1 min, and the number of times of the rinsing with pure water was changed to 1 time.

The electroconductive layer in the resultant transparent electroconductor of Sample No. 106 was found to have the amount of the halogen element of 1,200,000 ppm by mass when measured in the same manner as in Sample No. 101.

The resultant transparent electroconductor of Sample No. 106 was found to have the atomic ratio (X/A) of 3.4 when measured in the same manner as in Sample No. 101.

### <Production of Sample No. 107>

A transparent electroconductor of Sample No. 107 was produced in the same manner as in Sample No. 102, except that the silver nanowire dispersion (2) was used instead of the silver nanowire dispersion (1), the coating amount of silver was measured using a fluorescent X-ray analyzer (SEA1100, product of Seiko Instruments, Inc.), the coating amount was adjusted to 0.07 g/m², and the time for immersing in pure water was changed to 3 min.

The electroconductive layer in the resultant transparent electroconductor of Sample No. 107 was found to have the amount of the halogen element of 60,000 ppm by mass when measured in the same manner as in Sample No. 101.

The resultant transparent electroconductor of Sample No. 107 was found to have the atomic ratio (X/A) of 0.18 when measured in the same manner as in Sample

No. 101.

### <Production of Sample No. 108>

A transparent electroconductor of Sample No. 108 was produced in the same manner as in Sample No. 107, except that, upon immersing in pure water, pure water was changed to a mixture aqueous solution (0.1% by mass) containing potassium chloride, potassium bromide and potassium iodide and the time for immersing in pure water were changed to 1 min 30 sec.

The electroconductive layer in the resultant transparent electroconductor of Sample No. 108 was found to have the amount of the halogen element of 730,000 ppm by mass when measured in the same manner as in Sample No. 101.

The resultant transparent electroconductor of Sample No. 108 was found to have the atomic ratio (X/A) of 2.2 when measured in the same manner as in Sample No. 101.

### <Production of Sample No. 109>

A transparent electroconductor of Sample No. 109 was produced in the same manner as in Sample No. 104, except that the PET film used as a substrate for coating was bonded to the coated film which had been dried with the optical adhesive (PD-S1, product of PANAC CO., LTD.) using the handheld roller (W-130, product of Issin Industry Co., Ltd.) at 25° C. and 55% RH.

The amount of the halogen element and the atomic ratio (X/A) of Sample No. 104 were used because the electroconductive layer in the resultant transparent electroconductor of Sample No. 109 was equivalent to that of Sample No. 104.

<Production of Sample No. 110>

A transparent electroconductor of Sample No. 110 was produced in the same manner as in Sample No. 109, except that the PET film to be bonded was changed to the following LTV agent-containing polymer film.

The amount of the halogen element and the atomic ratio (X/A) of Sample No. 104 were used because the electroconductive layer in the resultant transparent electroconductor of Sample No. 110 was equivalent to that of Sample No. 104.

### <<Preparation of UV Agent-Containing Polymer Film>>

To polyethylene terephthalate (PET) (5 g), was added the Compound (I) represented by the following structural formula (15 mg) so as to have the absorbance at maximum absorption wavelength of 1.0 when a film with the thickness of 50 μm was formed. The resultant mixture was melt-kneaded at 265° C., followed by cooling to thereby obtain a LTV agent-containing polyethylene terephthalate. This UV agent-containing polyethylene terephthalate was drawn at 280° C. to thereby produce the LTV agent-containing polymer film.

### —Preparation of Compound (I)—

To 1.64 g (0.005 mol) of 1-(4,7-dihydroxybenzo[1,3]dithiol-2-ylidene) piperidinium acetate, were added 5 mL of N-methylpyrrolidone and 0.64 g (0.005 mol) of 1,2-dimethyl-3,5-pyrazolidinedione. The resultant mixture was stirred under a nitrogen flow at 100° C. for 30 min, followed by cooling and adding to 50 mL of dilute hydrochloric acid to thereby allow for a solid to precipitate. The resultant solid was filtered off to yield 1.63 g. Then, 0.310 g (0.001 mol) of the resultant compound was dissolved in 5 mL of dimethyl acetamide, and 0.304 g (0.003 mol) of triethylamine was added to the solution, followed by cooling to 0° C. Thereafter, to the resultant solution was added 0.390 g (0.0024 mol) of 2-ethylhexanoyl chloride, followed by warming to room temperature and stirring for 2 hours. The solution was treated with ethyl acetate and dilute hydrochloric acid, and isolated with a silica-gel column (hexane/ethyl acetate=9/1) to thereby obtain Compound (I) (yield: 0.30 g, 53%), which is an intended product.

Compound (I) represented by the following structural formulas was found to have the maximum absorption wavelength at 371 nm in a ethyl acetate solution, which demonstrated Compound (I) had absorbing power for long-wave ultraviolet light.

¹H NMR (CDCl₃) δ 0.95(6H), 1.06 (6H), 1.4-1.9 (16H), 2.6 (2H), 3.25 (6H), 7.3 ppm (2H).

FAB MS (Matrix: 3-nitrobenzyl alcohol) m/z 563 ([M+H]⁺), 562 ([M]⁺, 100%).

Anal. calcd. for C₂₈H₃₈N₂O₆S₂: C59.76%, H6.81%, N4.98%.

Found: C59.55%, H7.10%, N4.90%.

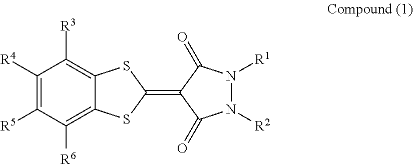

In Compound (I), R¹ and R² each represent a methyl group. R³ and R⁶ each represent 2-ethylhexanoyloxy. R⁴ and R⁵ each represent a hydrogen atom.

### <Production of Sample No. 111>

A transparent electroconductor of Sample No. 111 was produced in the same manner as in Sample No. 109, except that the PET film to be bonded was changed to the following gas-barrier film.

The amount of the halogen element and the atomic ratio (X/A) of Sample No. 104 were used because the electroconductive layer in the resultant transparent electroconductor of Sample No. 111 was equivalent to that of Sample No. 104.

### —Production of Gas-Barrier Film—

An inorganic layer and an organic layer were formed on a plastic film (PEN film; glass transition temperature (Tg): 120° C., product of Teijin DuPont Films Japan Limited) according to the following procedure.

### [1] Step of Producing Organic Layer

A coating liquid was produced by weighing 22.5 g of the following Polystyrene A1 and allowing it to be dissolved in 277.5 g of methyl ethyl ketone (MEK). This coating liquid was coated on the plastic film with bar coating, followed by drying to thereby form the organic layer, which has the thickness of 500 nm.

Polystyrene A1: weight average molecular weight (MW): 230,000, molecular weight distribution: 2.1, glass transition temperature (Tg): 94° C., product of Sigma-Aldrich Corporation.

### [2] Step of Heat Treatment

Thus produced organic layer was subjected to heat treatment under atmospheric pressure or reduced pressure of 100 Pa at 110° C. for 2 hours.

### [3] Step of Producing Inorganic Layer

After the heat treatment, using a sputtering method, an inorganic layer of aluminum oxide (A10) was formed with a reactive sputtering device as follows.

The pressure in a vacuum chamber of the reactive sputtering device was reduced to an ultimate pressure of 5×10⁻⁴ Pa via an oil rotary pump and a turbomolecular pump. Next, argon was introduced into the vacuum chamber as a plasma gas, and a power of 2,000 W was applied thereto from a plasma source. High-purity oxygen gas was introduced into the chamber, and the film formation pressure was adjusted to 0.3 Pa. At this pressure, a film was formed for a predetermined period to thereby obtain an inorganic layer of aluminum oxide (AlO) with the thickness of 40 nm.

Each of the transparent electroconductors of Sample Nos. 101 to 111 was evaluated for the following properties as follows. The results are shown in Tables 2-1 and 2-2.

### <Measurement of Transmittance and Haze>

Each of the electroconductive layers in the resultant transparent electroconductors was measured for the total light transmittance and haze using HAZE-GARD PLUS (product of GUARDNER Corporation).

### <Measurement of Surface Resistance>

Each of the electroconductive layers in the resultant transparent electroconductors was measured for the surface resistance using the surface resistance meter (LORESTA-GP MCP-T600, product of Mitsubishi Chemical Corporation).

In the case of the bonded sample, the surface resistance was measured with a non-contact type surface resistance meter (717B(H), product of DELCOM).

### <Evaluation of Light Resistance>

Each of the resultant transparent electroconductors was measured for the surface resistance (electroconductivity) before and after the accelerated light resistance test according to the above method for measuring the surface resistance. The ratio of the surface resistance before and after the test (the surface resistance after the test/the surface resistance before the test=M1/M0) was used for evaluating the light resistance. The accelerated light resistance test was performed for 72 hours using a Xenon weather meter (product of Suga Test Instruments Co., Ltd.) under the following settings: intensity of illumination: 180 W/m², back plate temperature: 60° C., and RH: 25%. Evaluation criteria were described below. Notably, the greater the number, the more excellent the light resistance.

### [Evaluation Criteria]

1: M1/M0 was less than 0.5 or 5 or more (the electroconductivity was significantly changed); problematic level in practical use.
2: M1/M0 was 0.5 or more and less than 0.65, or 1.3 or more and less than 5 (the electroconductivity was changed); problematic level in practical use.
3: M1/M0 was 0.65 or more and less than 0.75, or 1.2 or more and less than 1.3 (change of the electroconductivity was confirmed); non-problematic level in practical use.
4: M1/M0 was 0.75 or more and less than 0.9, or 1.1 or more and less than 1.2 (change of the electroconductivity was confirmed); non-problematic level in practical use.
5: M1/M0 was 0.9 or more and less than 1.1 (almost no change of the electroconductivity was confirmed); non-problematic level in practical use.

TABLE 2-1

| | | | Total amount of | Atomic | Surface | | |
|---|---|---|---|---|---|---|---|
| | Average minor | Average major | halogen | ratio | resistance | Transmittance | |
| Sample No. | axis length (nm) | axis length (μm) | (ppm by mass) | (X/A) | (Ω/sq.) | (%) | Notes |
| 101 | 23 | 32 | 3,000 | <0.01 | 421 | 89 | Comp. Sample |
| 102 | 23 | 32 | 50,000 | 0.15 | 62 | 88 | Present |
| | | | | | | | Invention |
| 103 | 23 | 32 | 160,000 | 0.48 | 61 | 88 | Present |
| | | | | | | | Invention |
| 104 | 23 | 32 | 260,000 | 0.78 | 63 | 88 | Present |
| | | | | | | | Invention |
| 105 | 23 | 32 | 420,000 | 1.25 | 62 | 87 | Comp. Sample |
| 106 | 23 | 32 | 1,200,000 | 3.4 | 69 | 86 | Comp. Sample |
| 107 | 105 | 42 | 60,000 | 0.18 | 104 | 87 | Present |
| | | | | | | | Invention |
| 108 | 105 | 42 | 730,000 | 2.2 | 123 | 86 | Comp. Sample |
| 109 | 23 | 32 | 260,000 | 0.78 | 61 | 86 | Present |
| | | | | | | | Invention |
| 110 | 23 | 32 | 260,000 | 0.78 | 61 | 84 | Present |
| | | | | | | | Invention |
| 111 | 23 | 32 | 260,000 | 0.78 | 61 | 80 | Present |
| | | | | | | | Invention |

* Sample No. 101 had low amount of halogen due to the ultrasonic washing, but the surface resistance of the electroconductive film was increased due to deterioration of the silver nanowires.

TABLE 2-2

| Sample No. | Haze (%) | Light resistance | Notes |
|---|---|---|---|
| 101 | 1.5 | 2 | Comp. Sample |
| 102 | 1.6 | 4 | Present Invention |
| 103 | 1.6 | 4 | Present Invention |
| 104 | 1.7 | 3 | Present Invention |
| 105 | 1.9 | 1 | Comp. Sample |
| 106 | 2.3 | 1 | Comp. Sample |
| 107 | 3.3 | 3 | Present Invention |
| 108 | 3.7 | 1 | Comp. Sample |
| 109 | 1.7 | 5 | Present Invention |
| 110 | 1.7 | 5 | Present Invention |
| 111 | 1.7 | 5 | Present Invention |

* Sample No. 101 had low durability because the silver nanowires had been cut due to the ultrasonic washing, therefore the number of the contact points decreased

### Example 2

### Production of Patterned Transparent Electroconductor

Patterned transparent electroconductors of Sample Nos. 201 to 215 shown in Table 3 were produced in the following manner. For evaluating the surface resistance, light transmittance and haze, non-patterned parts in the patterned transparent electroconductors were formed in the same manner as the below Samples except that the patterning step was not performed

<Production of Sample No. 201>

The silver nanowire dispersion (1) was mixed with the following negative photoresist so as to have the content ratio (solid content of silver nanowires/solid content of negative photoresist) of 1:1 to thereby prepare Electroconductive composition (1).

### <<Preparation of Negative Photoresist>>

### —Synthesis of Binder (A-1)—

Methacrylic acid (MAA) (7.79 g) and benzyl methacrylate (BzMA) (37.21 g) (serving as monomer components constituting a copolymer) were polymerized in propylene glycol monomethyl ether acetate (PGMEA) (55.00 g) (serving as a solvent) in the presence of azobisisobutyronitrile (AIBN) (0.5 g) (serving as a radical polymerization initiator) to thereby obtain a solution of Binder (A-1) in PGMEA (solid content concentration=45% by mass). Binder (A-1) is represented by the following formula. Notably, the polymerization temperature was adjusted to 60° C. to 100° C.

The molecular weight thereof was measured with a gel permeation chromatography (GPC) method, and was found to have a weight average molecular weight (Mw) converted to polystyrene of 30,000, and the molecular weight distribution (Mw/Mn) of 2.21.

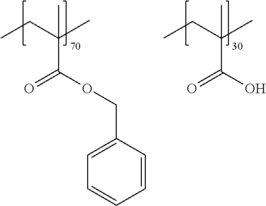

### —Preparation of Negative Photoresist—

To a solution of Binder (A-1) in PGMEA (solid content concentration=40.0% by mass) (3.80 parts by mass), were added KAYARAD DPHA (product of Nippon Kayaku Co., Ltd.) (1.59 parts by mass), IRGACURE 379 (product of Ciba Specialty Chemicals Co., Ltd.) (0.159 parts by mass), EHPE-3150 (product of Daicel Corporation, Ltd.) (0.150 parts by mass), MEGAFACE F781F (product of DIC Corporation) (0.002 parts by mass), and PGMEA (19.3 parts by mass), followed by stirring. Thereafter, the resultant solution was mixed with the silver nanowire dispersion (1) so as to have the final silver concentration of 1.0% by mass to thereby prepare a negative photoresist composition.

Next, the negative photoresist composition was coated using a doctor coater onto the surface of a commercially available heat-treated biaxially drawn polyethylene terephthalate (PET) support having a thickness of 100 μm, followed by drying to thereby form an electroconductive layer. The coating amount of silver nanowires was found to be 0.06 g/m² with a fluorescent X-ray analyzer (SEA1100, product of Seiko Instruments, Inc.)

### —Patterning Treatment—

The thus-obtained electroconductive layer was subjected to patterning treatment to thereby form striped patterns with line-and-space (hereinafter referred to as “L/S”)=100 μm/20 μm. Thus, the patterned transparent electroconductor of Sample No. 201 was produced.

### —Patterning Conditions—

Through a mask, light exposure was performed using i-line of a high-pressure mercury lamp (365 nm) at 100 mJ/cm² (intensity of illumination: 20 mW/cm²). A developing liquid in which 5 g of sodium hydrogen carbonate and 2.5 g of sodium carbonate are dissolved in 5,000 g of pure water was showered on the exposed layer for 30 sec. The showering pressure was set at 0.04 MPa. The time it took for the striped pattern to appear was 15 sec.

Next, the resultant patterned transparent electroconductor was rinsed through showering of pure water at 25° C. for 1 min, followed by immersing in pure water at 25° C. for 5 min, further subjecting to ultrasonic washing for 2 min and rinsing with pure water twice in the same manner as that of Sample No. 101.

For the electroconductive layer (electroconductive film) in the resultant patterned transparent electroconductor of Sample No. 201, the amount of the halogen element was measured in the same manner as in Example 1, and was found to be 2,900 ppm by mass.

For the resultant patterned transparent electroconductor of Sample No. 201, the atomic ratio (X/A) of the amount of silver constituting the silver nanowires in the electroconductive film (A) and the amount of the halogen element in the electroconductive layer (X) was measured in the same manner as in Example 1 and was found to be <0.01.

### <Production of Sample No. 202>

A patterned transparent electroconductor of Sample No. 202 was produced in the same manner as in Sample No. 201, except that the time for immersing in pure water was changed to 2 min.

The electroconductive layer in the resultant patterned transparent electroconductor of Sample No. 202 was found to have the amount of the halogen element of 47,000 ppm by mass when measured in the same manner as in Sample No. 201.

The resultant patterned transparent electroconductor of Sample No. 202 was found to have the atomic ratio (X/A) of 0.14 when measured in the same manner as in Sample No. 201.

### <Production of Sample No. 203>

A patterned transparent electroconductor of Sample No. 203 was produced in the same manner as in Sample No. 201, except that the time for immersing in pure water was changed to 30 sec.

The electroconductive layer in the resultant patterned transparent electroconductor of Sample No. 203 was found to have the amount of the halogen element of 160,000 ppm by mass when measured in the same manner as in Sample No. 201.

The resultant patterned transparent electroconductor of Sample No. 203 was found to have the atomic ratio (X/A) of 0.46 when measured in the same manner as in Sample No. 201.

### <Production of Sample No. 204>

A patterned transparent electroconductor of Sample No. 204 was produced in the same manner as in Sample No. 201, except that the immersing in pure water and the rinsing with pure water twice were not performed.

The electroconductive layer in the resultant patterned transparent electroconductor of Sample No. 204 was found to have the amount of the halogen element of 280,000 ppm by mass when measured in the same manner as in Sample No. 201.

The resultant patterned transparent electroconductor of Sample No. 204 was found to have the atomic ratio (X/A) of 0.85 when measured in the same manner as in Sample No. 201.

### <Production of Sample No. 205>

A patterned transparent electroconductor of Sample No. 205 was produced in the same manner as in Sample No. 201, except that, upon immersing in pure water, pure water was changed to a mixture aqueous solution (0.1% by mass) containing potassium chloride, potassium bromide, and potassium iodide and the time for immersing was changed to 45 sec.

The electroconductive layer in the resultant patterned transparent electroconductor of Sample No. 205 was found to have the amount of the halogen element of 420,000 ppm by mass when measured in the same manner as in Sample No. 201.

The resultant patterned transparent electroconductor of Sample No. 205 was found to have the atomic ratio (X/A) of 1.27 when measured in the same manner as in Sample No. 201.

### <Production of Sample No. 206>

A patterned transparent electroconductor of Sample No. 206 was produced in the same manner as in Sample No. 201, except that, upon immersing in pure water, pure water was changed to a mixture aqueous solution (0.1% by mass) containing potassium chloride, potassium bromide, and potassium iodide, the time for immersing was changed to 1 min 30 seconds, and the number of times of the rinsing with pure water was changed to 1 time.

The electroconductive layer in the resultant patterned transparent electroconductor of Sample No. 206 was found to have the amount of the halogen element of 1,020,000 ppm by mass when measured in the same manner as in Sample No. 201.

The resultant patterned transparent electroconductor of Sample No. 206 was found to have the atomic ratio (X/A) of 3.1 when measured in the same manner as in Sample No. 201.

### <Production of Sample No. 207>

A patterned transparent electroconductor of Sample No. 207 was produced in the same manner as in Sample No. 201, except that the silver nanowire dispersion (2) was used instead of the silver nanowire dispersion (1), the coating amount of silver was measured using a fluorescent X-ray analyzer (SEA1100, product of Seiko Instruments, Inc.), the coating amount was adjusted to 0.07 g/m², and the time for immersing in pure water was changed to 8 min

The electroconductive layer in the resultant patterned transparent electroconductor of Sample No. 207 was found to have the amount of the halogen element of 53,000 ppm by mass when measured in the same manner as in Sample No. 201.

The resultant patterned transparent electroconductor of Sample No. 207 was found to have the atomic ratio (X/A) of 0.16 when measured in the same manner as in Sample No. 201.

### <Production of Sample No. 208>

A patterned transparent electroconductor of Sample No. 208 was produced in the same manner as in Sample No. 207, except that, upon immersing in pure water, pure water was changed to a mixture aqueous solution (0.1% by mass) containing potassium chloride, potassium bromide, and potassium iodide, the time for immersing was changed to 2 min 30 seconds, and the number of times of the rinsing with pure water was changed to 1 time.

The electroconductive layer in the resultant patterned transparent electroconductor of Sample No. 208 was found to have the amount of the halogen element of 630,000 ppm by mass when measured in the same manner as in Sample No. 201.

The resultant patterned transparent electroconductor of Sample No. 208 was found to have the atomic ratio (X/A) of 1.9 when measured in the same manner as in Sample No. 201.

### <Production of Sample No. 209>

A patterned transparent electroconductor of Sample No. 209 was produced in the same manner as in Sample No. 204, except that the PET film used as a substrate for coating was bonded to the patterned film with the optical adhesive (PD-S1, product of PANAC CO., LTD.) using the handheld roller (W-130, product of Issin Industry Co., Ltd.) at 25° C. and 55% RH.

The amount of the halogen element and the atomic ratio (X/A) of Sample No. 204 were used because the electroconductive layer in the resultant transparent electroconductor of Sample No. 209 was equivalent to that of Sample No. 204.

### <Production of Sample No. 210>

A patterned transparent electroconductor of Sample No. 210 was produced in the same manner as in Sample No. 209, except that the PET film to be bonded was changed to the UV-agent containing polymer film made in production of Sample No. 110.

The amount of the halogen element and the atomic ratio (X/A) of Sample No. 204 were used because the electroconductive layer in the resultant transparent electroconductor of Sample No. 210 was equivalent to that of Sample No. 204.

### <Production of Sample No. 211>

A patterned transparent electroconductor of Sample No. 211 was produced in the same manner as in Sample No. 209, except that the PET film to be bonded was changed to the gas-barrier film made in production of Sample No. 111.

The amount of the halogen element and the atomic ratio (X/A) of Sample No. 204 were used because the electroconductive layer in the resultant transparent electroconductor of Sample No. 211 was equivalent to that of Sample No. 204.

### <Production of Sample No. 212>

The electroconductive film of Sample No. 104 was patterned using the following screen printing method to thereby produce the patterned transparent electroconductor of Sample No. 212.

### —Screen Printing Method—

The screen printing method was performed with WHT-3 (desktop vacuum printing table) and a squeegee No. 4 yellow (all product of MINO GROUP CO., LTD.) A dissolution liquid was prepared by mixing CP-48S-A liquid and CP-48S-B liquid (all products of FUJIFILM Corporation) with pure water at the mass ratio of 1:1:1, followed by thickening with ARON A-20L (product of TOAGOSEI CO., LTD.)

The viscosity of the dissolution liquid which dissolves silver nanowires was 31,000 mPa·s at 25° C. Notably, the viscosity was measured with the Brookfield viscometer.

The electroconductive layer in the resultant patterned transparent electroconductor of Sample No. 212 was found to have the amount of the halogen element of 195,000 ppm by mass when measured in the same manner as in Sample No. 201.

The resultant patterned transparent electroconductor of Sample No. 212 was found to have the atomic ratio (X/A) of 0.58 when measured in the same manner as in Sample No. 201.

### <Production of Sample No. 213>

The electroconductive film of Sample No. 104 was patterned using the following inkjet method to thereby produce the patterned transparent electroconductor with Sample No. 213.

### —Inkjet Method—

The inkjet method was performed with MATERIAL PRINTER DMP-2831 (product of FUJIFILM Corporation). A dissolution liquid was prepared by mixing CP-48S-A liquid and CP-48S-B liquid (all products of FUJIFILM Corporation) with pure water at the mass ratio of 1:1:6, followed by thickening with ARON A-20L (product of TOAGOSEI CO., LTD.)

The viscosity of the dissolution liquid which dissolves silver nanowires was 10 mPa·s at 25° C. Notably, the viscosity was measured with the Brookfield viscometer.

The electroconductive layer in the resultant patterned transparent electroconductor of Sample No. 213 was found to have the amount of the halogen element of 210,000 ppm by mass when measured in the same manner as in Sample No. 201.

The resultant patterned transparent electroconductor of Sample No. 213 was found to have the atomic ratio (X/A) of 0.62 when measured in the same manner as in Sample No. 201.

### <Production of Sample No. 214>

The electroconductive film of Sample No. 104 was patterned using the following resist etching method to thereby produce the patterned transparent electroconductor with Sample No. 214.

### —-Resist Etching Method—

A photoresist patterned film was formed in the same manner as described above on the electroconductive layer produced in the same manner as in Sample No. 104 using the negative photoresist liquid produced in Sample No. 201. A dissolution liquid was prepared by mixing CP-48S-A liquid and CP-48S-B liquid (all products of FUJIFILM Corporation) with pure water at the mass ratio of 1:1:6, followed by thickening with ARON A-20L (product of TOAGOSEI CO., LTD.)

The viscosity of the dissolution liquid in which silver nanowires are to be dissolve was 10 mPa·s at 25° C. Notably, the viscosity was measured with the Brookfield viscometer.

Then, a laminate in which the photoresist patterned film is provided on the resultant electroconductive film was immersed in a bath containing the dissolution liquid at 25° C. for 1 min, followed by rinsing the components of the dissolution liquid with pure water for 2 min. The photoresist was removed by immersing the laminate in 10% by mass potassium hydroxide solution to thereby obtain the patterned electroconductive film of Sample No. 214.

The electroconductive layer in the resultant patterned transparent electroconductor of Sample No. 214 was found to have the amount of the halogen element of 186,000 ppm by mass when measured in the same manner as in Sample No. 201.

The resultant patterned transparent electroconductor of Sample No. 214 was found to have the atomic ratio (X/A) of 0.56 when measured in the same manner as in Sample No. 201.

### <Production of Sample No. 215>

A patterned transparent electroconductor of Sample No. 215 was produced in the same manner as in Sample No. 214, except that a transfer film black (for black matrix) (product of FUJIFILM Corporation) was used instead of the negative type photoresist.

The electroconductive layer in the resultant patterned transparent electroconductor of Sample No. 215 was found to have the amount of the halogen element of 200,000 ppm by mass when measured in the same manner as in Sample No. 201.

The resultant patterned transparent electroconductor of Sample No. 215 was found to have the atomic ratio (X/A) of 0.59 when measured in the same manner as in Sample No. 201.

Each of the patterned transparent electroconductors produced in Sample Nos. 201 to 215 was evaluated for the above-mentioned properties in the same manner as in Sample Nos. 101 to 111. In addition, insulating property and resolution were evaluated in the following manner. The results are shown in Table 3.

### <Insulating Property (Migration Resistance)>

For each of the resultant transparent electroconductors, non-electroconductive parts in the patterned area were measured for the surface resistance using the surface resistance meter (LORESTA-GP MCP-T600, product of Mitsubishi Chemical Corporation). Actually, the modified surface resistance meter was used in that a copper wire was provided on the tip of a probe so as to be able to measure the surface resistance even in an area having a fine pattern. Evaluation criteria were described below. Notably, the greater the number, the more excellent the resolution.

### [Evaluation Criteria]

1: The surface resistance was less than 10⁴ Ω/sq. (the areas formed as non-electroconductive parts had high electroconductivity); problematic level in practical use.
2: The surface resistance was 10⁴ Ω/sq. or more and less than 10⁵ Ω/sq. (the areas formed as non-electroconductive parts had high electroconductivity); problematic level in practical use.
3: The surface resistance was 10⁵ Ω/sq. or more and less than 10⁶ Ω/sq. (the areas formed as non-electroconductive parts had confirmable electroconductivity); non-problematic level in practical use.
4: The surface resistance was 10⁶ Ω/sq. or more and less than 10⁷ Ω/sq. (the areas formed as non-electroconductive parts had confirmable electroconductivity); non-problematic level in practical use.
5: The surface resistance was 10⁷ Ω/sq. or more (displayed as “O. L.” on the device) (almost no electroconductivity was confirmed); non-problematic level in practical use.

### <Evaluation of Resolution>

A pattern with L (line)/S (space)=100 μm/30 μm was formed in the same manner as each of the resultant transparent electroconductors. The width of the electroconductive part in the patterned area was observed under an optical microscope. Evaluation criteria were described below. Notably, the greater the number, the more excellent the resolution.

### [Evaluation Criteria]

1: Width of the electroconductive part was less than 60 μm or 115 μm or more (substantially indistinguishable from the adjacent line); problematic level in practical use.
2: Width of the electroconductive part was less than 70 μm or 112 μm or more; problematic level in practical use.
3: Width of the electroconductive part was less than 80 μm or 110 μm or more; non-problematic level in practical use.
4: Width of the electroconductive part was less than 90 μm or 108 μm or more; non-problematic level in practical use.
5: Width of the electroconductive part was less than 94 μm or 106 μm or more; non-problematic level in practical use.

TABLE 3-1

| | | | | | Total amount of | Atomic | |
|---|---|---|---|---|---|---|---|
| Sample | | Average minor | Average major | Amount of silver | halogen | ratio | |
| No. | Patterning method | axis length (nm) | axis length (μm) | (g/m²) | (ppm by mass) | (X/A) | Notes |
| 201 | Photoresist in AgNW | 23 | 32 | 0.06 | 2,900 | <0.01 | Comp. |
| | | | | | | | Sample |
| 202 | Photoresist in AgNW | 23 | 32 | 0.06 | 47,000 | 0.14 | Present |
| | | | | | | | Invention |
| 203 | Photoresist in AgNW | 23 | 32 | 0.06 | 160,000 | 0.46 | Present |
| | | | | | | | Invention |
| 204 | Photoresist in AgNW | 23 | 32 | 0.06 | 280,000 | 0.85 | Present |
| | | | | | | | Invention |
| 205 | Photoresist in AgNW | 23 | 32 | 0.06 | 420,000 | 1.27 | Comp. |
| | | | | | | | Sample |
| 206 | Photoresist in AgNW | 23 | 32 | 0.06 | 1,020,000 | 3.1 | Comp. |
| | | | | | | | Sample |
| 207 | Photoresist in AgNW | 105 | 42 | 0.07 | 53,000 | 0.16 | Present |
| | | | | | | | Invention |
| 208 | Photoresist in AgNW | 105 | 42 | 0.07 | 630,000 | 1.9 | Comp. |
| | | | | | | | Sample |
| 209 | Photoresist in AgNW | 23 | 32 | 0.06 | 280,000 | 0.85 | Present |
| | | | | | | | Invention |
| 210 | Photoresist in AgNW | 23 | 32 | 0.06 | 280,000 | 0.85 | Present |
| | | | | | | | Invention |
| 211 | Photoresist in AgNW | 23 | 32 | 0.06 | 280,000 | 0.85 | Present |
| | | | | | | | Invention |
| 212 | Screen | 23 | 32 | 0.06 | 195,000 | 0.58 | Present |
| | | | | | | | Invention |
| 213 | Inkjet | 23 | 32 | 0.06 | 210,000 | 0.62 | Present |
| | | | | | | | Invention |
| 214 | Resist etching | 23 | 32 | 0.06 | 186,000 | 0.56 | Present |
| | | | | | | | Invention |
| 215 | Transer etching | 23 | 32 | 0.06 | 200,000 | 0.59 | Present |
| | | | | | | | Invention |

TABLE 3-2

| | Surface | Trans- | | | | | |
|---|---|---|---|---|---|---|---|
| Sample | resistance | mittance | | Light | Insulating | | |
| No. | (Ω/sq) | (%) | Haze(%) | resistance | property | Resolution | Notes |
| 201 | 541 | 89 | 1.5 | 2 | 4 | 4 | Comp. |
| | | | | | | | Sample |
| 202 | 66 | 88 | 1.6 | 4 | 4 | 5 | Present |
| | | | | | | | Invention |
| 203 | 65 | 88 | 1.6 | 4 | 4 | 4 | Present |
| | | | | | | | Invention |
| 204 | 67 | 88 | 1.7 | 3 | 3 | 4 | Present |
| | | | | | | | Invention |
| 205 | 64 | 87 | 1.9 | 1 | 1 | 2 | Comp. |
| | | | | | | | Sample |
| 206 | 74 | 86 | 2.3 | 1 | 1 | 1 | Comp. |
| | | | | | | | Sample |
| 207 | 144 | 87 | 3.3 | 3 | 3 | 4 | Present |
| | | | | | | | Invention |
| 208 | 165 | 86 | 3.7 | 1 | 1 | 1 | Comp. |
| | | | | | | | Sample |
| 209 | 65 | 86 | 1.9 | 5 | 5 | 4 | Present |
| | | | | | | | Invention |
| 210 | 65 | 84 | 1.8 | 5 | 5 | 4 | Present |
| | | | | | | | Invention |
| 211 | 65 | 80 | 2.1 | 5 | 5 | 4 | Present |
| | | | | | | | Invention |
| 212 | 64 | 87 | 1.7 | 5 | 4 | 5 | Present |
| | | | | | | | Invention |
| 213 | 63 | 87 | 1.7 | 5 | 3 | 4 | Present |
| | | | | | | | Invention |
| 214 | 62 | 86 | 1.7 | 5 | 3 | 4 | Present |
| | | | | | | | Invention |
| 215 | 62 | 86 | 1.7 | 5 | 3 | 4 | Present |
| | | | | | | | Invention |

*Sample No. 201 had increased surface resistance and decreased durability because the silver nanowires had been cut due to the ultrasonic washing, therefore the number of the contact points decreased.

### Example 3

### Production of Touch Panel

Touch panels were produced using the patterned transparent electroconductor of Sample No. 202 by a known method described in, for example, “Latest Touch Panel Technology (Saishin Touch Panel Gijutsu)” (published on Jul. 6, 2009 from Techno Times Co.), supervised by Yuji Mitani, “Development and Technology of Touch Panel (Touch Panel no Gijustu to Kaihatsu),” published from CMC (December, 2004), FPD International 2009 Forum T-11 Lecture Text Book, Cypress Semiconductor Corporation Application Note AN2292.

By virtue of improvement in transmittance, it was found that touch panels produced therefrom were excellent in visibility. In addition, by virtue of improvement in electroconductivity, it was also found that touch panels produced therefrom were excellent in response to input of, for example, characters or screen touch with at least one of a bare hand, a hand wearing a glove and a pointing tool. Notably, the touch panel encompasses so-called touch sensors and touch pads.

### Example 4

### Production of Integrated Solar Battery

### —Production of Amorphous Solar Battery (Super Straight Type)—

The transparent electroconductor of Sample No. 102 was formed on a glass substrate. Through plasma chemical vapor deposition, a p-type amorphous silicon layer having a thickness of 15 nm was formed on the transparent electroconductor, an i-type amorphous silicon layer having a thickness of 350 nm was formed on the p-type amorphous silicon layer, an n-type amorphous silicon layer having a thickness of 30 nm was formed on the i-type amorphous silicon layer, a gallium-doped zinc oxide layer having a thickness of 20 nm was formed on the n-type amorphous silicon layer as a backside reflecting electrode, and a silver layer having a thickness of 200 nm was formed on the gallium-doped zinc oxide layer, to thereby produce photoelectric conversion element.

### Example 5

### Production of Integrated Solar Battery

### —Production of CIGS Solar Battery (Substrate Type)—

A molybdenum electrode having a thickness of about 500 nm was formed on a glass substrate through DC magnetron sputtering. A 2.5 μm-thick thin film of Cu(In_{0.6}Ga_{0.4})Se₂ (a chalcopyrite semiconductor material) was formed on the electrode through vacuum vapor deposition. A cadmium sulfide thin film having a thickness of 50 nm was formed on the Cu(In_{0.6}Ga_{0.4})Se₂ thin film through solution deposition. The transparent electroconductor of Sample No. 102 was formed on the cadmium sulfide thin film, to thereby produce photoelectric conversion element.

### <Evaluation of Solar Battery Performance (Conversion Efficiency)>

The solar batteries of Example 4 and 5 were irradiated with artificial sunlight of AM1.5 at 100 mW/cm² to evaluate the solar battery performance (conversion efficiency). The results are shown in Table 4.

TABLE 4

| | Conversion efficiency (%) |
|---|---|
| Example 4 | 8 |
| Example 5 | 9 |

The electroconductive film of the present invention has high transmittance with respect to lights with long wavelengths, high electroconductivity, and improved light resistance and migration resistance, and thus, can be used for a touch panel, an antistatic display film, an electromagnetic shield, an organic or inorganic EL display electrode, an electronic paper electrode, a flexible display electrode, an antistatic flexible display film, a solar battery electrode, and other various devices.

What is claimed is:

1. An electroconductive film comprising:
electroconductive fibers,
wherein the electroconductive film satisfies the following expression:
0.01<X/A<0.9,
where X/A is an atomic ratio of X to A, where A is an amount of elements constituting the electroconductive fibers in the electroconductive film and X is an amount of halogen elements in the electroconductive film.

2. The electroconductive film according to claim 1, wherein the electroconductive film satisfies the following expression: 0.1≦X/A<0.9.

3. The electroconductive film according to claim 1, wherein the electroconductive film satisfies the following expression: 0.4≦X/A<0.9.

4. The electroconductive film according to claim 1, wherein the amount of the halogen elements in the electroconductive film is 400,000 ppm by mass or less.

5. The electroconductive film according to claim 4, wherein the amount of the halogen elements in the electroconductive film is 4,000 ppm by mass to 300,000 ppm by mass.

6. The electroconductive film according to claim 1, wherein the electroconductive film has a surface resistance of 500 Ω/sq. or less.

7. The electroconductive film according to claim 1, wherein the electroconductive fibers are metal nanowires.

8. The electroconductive film according to claim 7, wherein the metal nanowires are formed of silver or formed of an alloy formed between silver and a metal other than silver.

9. The electroconductive film according to claim 1, wherein the electroconductive fibers have an average minor axis length of 50 nm or less and have an average major axis length of 1 μm or more.

10. The electroconductive film according to claim 1, wherein an amount of the electroconductive fibers in the electroconductive film is 0.005 g/m² to 0.5 g/m².

11. The electroconductive film according to claim 1, further comprising a polymer, wherein a mass ratio of A to B is 0.2 to 3, where A is an amount of the electroconductive fibers in the electroconductive film and B is an amount of the polymer in the electroconductive film.

12. A touch panel comprising:
an electroconductive film which comprises:
electroconductive fibers,
wherein the electroconductive film satisfies the following expression:
0.01<X/A<0.9,
where X/A is an atomic ratio of X to A, where X is an amount of elements constituting the electroconductive fibers in the electroconductive film and X is an amount of halogen elements in the electroconductive film.

13. A solar battery comprising:
an electroconductive film which comprises:
electroconductive fibers,
wherein the electroconductive film satisfies the following expression:
0.01<X/A<0.9,
where X/A is an atomic ratio of X to A, where X is an amount of elements constituting the electroconductive fibers in the electroconductive film and X is an amount of halogen elements in the electroconductive film.
